(19) United States
(12) Patent Application Publication
(10) Pub. No.: US 2022/0116286 A1
(43) Pub. Date: Apr. 14, 2022

(54) METHODS AND APPARATUS TO IMPLEMENT EDGE SCALABLE ADAPTIVE-GRAINED MONITORING AND TELEMETRY PROCESSING FOR MULTI-QOS SERVICES

(71) Applicant: Intel Corporation, Santa Clara, CA (US)

(72) Inventors: Kshitij Arun Doshi, Tempe, AZ (US); Francesc Guim Bernat, Barcelona (ES)

(21) Appl. No.: 17/645,734

(22) Filed: Dec. 22, 2021

(51) Int. Cl. H04L 41/5025; H04L 41/50; H04L 41/5009

(52) U.S. Cl. CPC H04L 41/5025; H04L 41/5009; H04L 41/5032

(57) ABSTRACT

Methods and apparatus to implement edge scalable adaptive-grained monitoring and telemetry processing for multi-quality of service (QoS) services are disclosed. In one example, the apparatus includes platform compute circuitry. The apparatus also includes both a monitoring function registry interface data structure to list a set of monitoring functions that provide at least a unique universal function identifier and a function descriptor and an application assignment interface data structure that provide at least an application identifier, an application service level agreement (SLA) definition, and the function descriptor to enable a link to a first monitoring function. Additionally, the apparatus includes an SLA monitoring circuitry that instantiates the first monitoring function for an application instance in a logic stack, causes the first monitoring function to execute in the hardware and software monitoring logic stack, and generates a QoS enforcement callback in response to a violation of the SLA definition.

### FIELD OF THE DISCLOSURE

This disclosure relates generally to monitoring telemetry data for service level agreements and, more particularly, to implementing edge scalable adaptive-grained monitoring and telemetry processing for multi-quality of service (QoS) services.

### BACKGROUND

In recent years, telemetry collection and processing has become important throughout the computing industry. Telemetry collection and processing involves sampling many hardware and software metrics, delivering them to one or more receiving points, and using them to understand where, when, and how computational resources are multiplexed among tasks/services so that service level agreements (SLAs), or quality of service (QoS) objectives are achieved with an efficient utilization of resources. Typically, platform software stacks collect and process telemetry at large to apportion central processing unit (CPU) cycles, memory/input-output (I/O) bandwidths, power, and other resources that have contention. Some service level objectives apply also to the infrastructural tasks/service(s) for ensuring timely collection and processing of telemetry. These activities are tied up with the responsibilities of provisioning and load balancing, which causes data centers to provide them implicit priority. The coordination, automation, and management of the services, as well as of the resources such services require, are integral constituents of data center cloud architectures.

### BRIEF DESCRIPTION OF THE DRAWINGS

FIG. 1 is a block diagram showing an overview of a configuration for Edge computing, which includes a layer of processing referred to in many of the following examples as an “Edge cloud”.

FIG. 2 illustrates example operational layers among endpoints, an Edge cloud, and cloud computing environments.

FIG. 3 illustrates various example client endpoints (in the form of mobile devices, computers, autonomous vehicles, business computing equipment, industrial processing equipment) exchange requests and responses that are specific to the type of endpoint network aggregation.

FIG. 4 illustrates example deployment and orchestration for virtualized and container-based Edge configurations across an Edge computing system operated among multiple Edge nodes and multiple tenants (e.g., users, providers) which use such Edge nodes.

FIG. 5 illustrates example additional compute arrangements deploying containers in an Edge computing system.

FIG. 6 provides an overview of example components for compute deployed at a compute node in an Edge computing system.

FIG. 7 provides a further overview of example components within a computing device in an Edge computing system.

FIG. 8 is a schematic diagram of an example infrastructure processing unit (IPU).

FIG. 9 is a schematic illustration of an example apparatus to implement edge-scalable adaptive-grained monitoring and telemetry processing for multi-QoS services.

FIG. 10 is an illustration of the detail in an example monitoring function registry interface data structure and an example application assignment interface data structure.

FIG. 11A is a schematic illustration of an example apparatus including detailed circuitry implemented within an SLA monitoring logic circuitry.

FIG. 11B is a schematic illustration of an example apparatus including detailed telemetry function executor circuitry implemented within a general processor circuitry, a general accelerator circuitry, and/or a telemetry function accelerator circuitry.

FIG. 12 is a flowchart representative of example machine readable instructions and/or example operations that may be executed and/or instantiated by processor circuitry to instantiate and cause a telemetry monitoring function to run and report SLA violations in a compute node.

FIG. 13 is a flowchart representative of example machine readable instructions and/or example operations that may be executed and/or instantiated by processor circuitry to parse a telemetry monitoring function, configure a logic stack to run the telemetry monitoring function, and directly execute the parsed operations in a compute node.

FIG. 14 is a flowchart representative of example machine readable instructions and/or example operations that may be executed and/or instantiated by processor circuitry to instantiate a monitoring function in one of several compute circuitries based on an application instance criticality level.

FIG. 15 is a flowchart representative of example machine readable instructions and/or example operations that may be executed and/or instantiated by processor circuitry to monitor the utilization rate of a platform resource and execute a monitoring function on a specific platform resource as a result of the utilization rate being below a threshold value.

FIG. 16 is a flowchart representative of example machine readable instructions and/or example operations that may be executed and/or instantiated by processor circuitry to manage the frequency of the execution of a monitoring function.

FIG. 17 is a block diagram of an example processing platform including processor circuitry structured to execute the example machine readable instructions of FIG. 12 to implement edge scalable adaptive-grained monitoring and telemetry processing for multi-QoS services.

FIG. 18 is a block diagram of an example implementation of the processor circuitry of FIG. 17.

FIG. 19 is a block diagram of another example implementation of the processor circuitry of FIG. 17.

FIG. 20 is a block diagram of an example software distribution platform (e.g., one or more servers) to distribute software (e.g., software corresponding to the example machine readable instructions of FIGS. 12-16) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

The world is rapidly entering a next stage of cloud computing, which exhibits some key characteristics, such as:
(a) real-time or nearly instantaneous fulfilment of requests,
(b) fluid allocation and deallocation of resources—particularly with the virtualization of network data and control planes across software defined infrastructures,
(c) elastic growth in demand, driven by an ever increasing richness of information mined from data, and
(d) very high densities of multi-tenant services launched just-in-time.

Mobility and real-time requirements are pushing cloud computing into decentralized Edge clouds. As a result, orchestration is also highly distributed and decentralized instead of being driven by a single seat of intelligence. Accordingly, telemetry collection and processing (e.g., data collected from nodes and systems that includes information as to the availability of processing power and time for services) is also being decentralized to maintain efficiencies. As scheduling and quality of service (QoS) complexity increases, so does the telemetry cost, which may be considered the outlay of resources whose utilization does not contribute to the computational productivity that meets the requested demand. However, unlike cloud data centers, Edge data centers are tightly constrained both in available resources (and therefore how much gets eaten up by the telemetry cost) and the time available for determining how best to multiplex them—even though such determinations may be very compute intensive for the most demanding service level agreements (SLAs).

Thus, it is desired to:
[1] Provide richer monitoring and SLA infrastructure with the necessary accuracy and granularity against requirements,
[2] Achieve it elastically at the Edge despite the constraints,
[3] Keep overheads low, and
[4] Focus the processing of telemetry where needed, and not everywhere.

For instance, one service A may be critical and require more real-time, fine-grained, and complicated telemetry processing to run effectively, but another service B may be less reliability-critical than service A, requiring just starvation avoidance to complete its task successfully.

Currently, tools such as Perf were effective with traditional software but are not effective with new Edge deployments. Sampling to obtain telemetry data in nodes in modern Edge networks is complicated when a given system/node has thousands of running functions and correlating the counters back to the specific function that was executed.

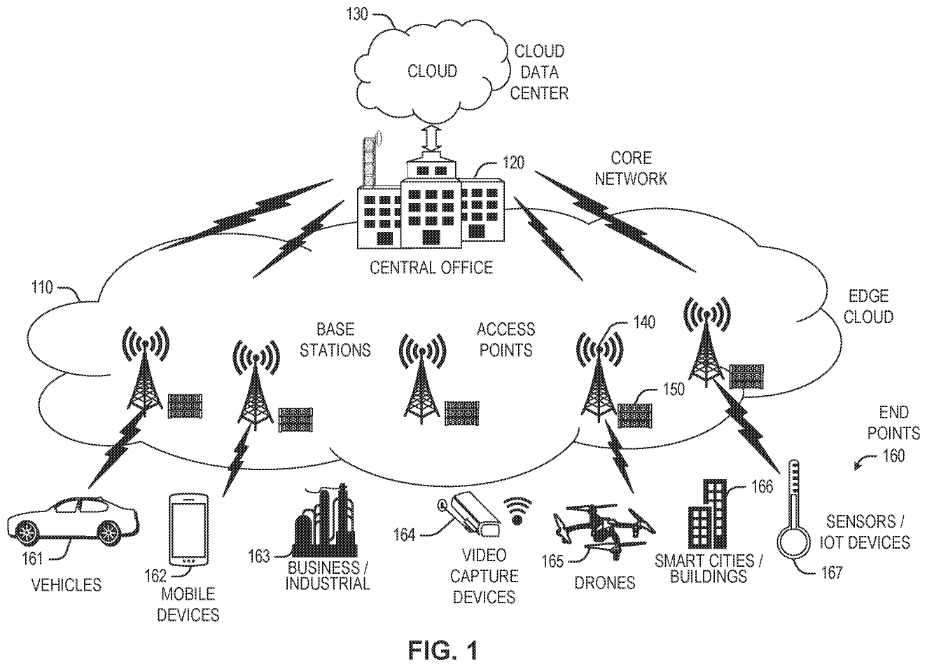

FIG. 1 is a block diagram 100 showing an overview of a configuration for Edge computing, which includes a layer of processing referred to in many of the following examples as an “Edge cloud”. As shown, the Edge cloud 110 is co-located at an Edge location, such as an access point or base station 140, a local processing hub 150, or a central office 120, and thus may include multiple entities, devices, and equipment instances. The Edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the Edge cloud 110 are critical to providing ultra-low latency response times for services and functions used by the endpoint data sources 160 as well as reduce network backhaul traffic from the Edge cloud 110 toward cloud data center 130 thus improving energy consumption and overall network usages among other benefits.

Compute, memory, and storage are scarce resources, and generally decrease depending on the Edge location (e.g., fewer processing resources being available at consumer endpoint devices, than at a base station, than at a central office). However, the closer that the Edge location is to the endpoint (e.g., user equipment (UE)), the more that space and power is often constrained. Thus, Edge computing attempts to reduce the amount of resources needed for network services, through the distribution of more resources which are located closer both geographically and in network access time. In this manner, Edge computing attempts to bring the compute resources to the workload data where appropriate, or, bring the workload data to the compute resources.

The following describes aspects of an Edge cloud architecture that covers multiple potential deployments and addresses restrictions that some network operators or service providers may have in their own infrastructures. These include, variation of configurations based on the Edge location (because edges at a base station level, for instance, may have more constrained performance and capabilities in a multi-tenant scenario); configurations based on the type of compute, memory, storage, fabric, acceleration, or like resources available to Edge locations, tiers of locations, or groups of locations; the service, security, and management and orchestration capabilities; and related objectives to achieve usability and performance of end services. These deployments may accomplish processing in network layers that may be considered as “near Edge”, “close Edge”, “local Edge”, “middle Edge”, or “far Edge” layers, depending on latency, distance, and timing characteristics.

Edge computing is a developing paradigm where computing is performed at or closer to the “Edge” of a network, typically through the use of a compute platform (e.g., x86 or ARM compute hardware architecture) implemented at base stations, gateways, network routers, or other devices which are much closer to endpoint devices producing and consuming the data. For example, Edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within Edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

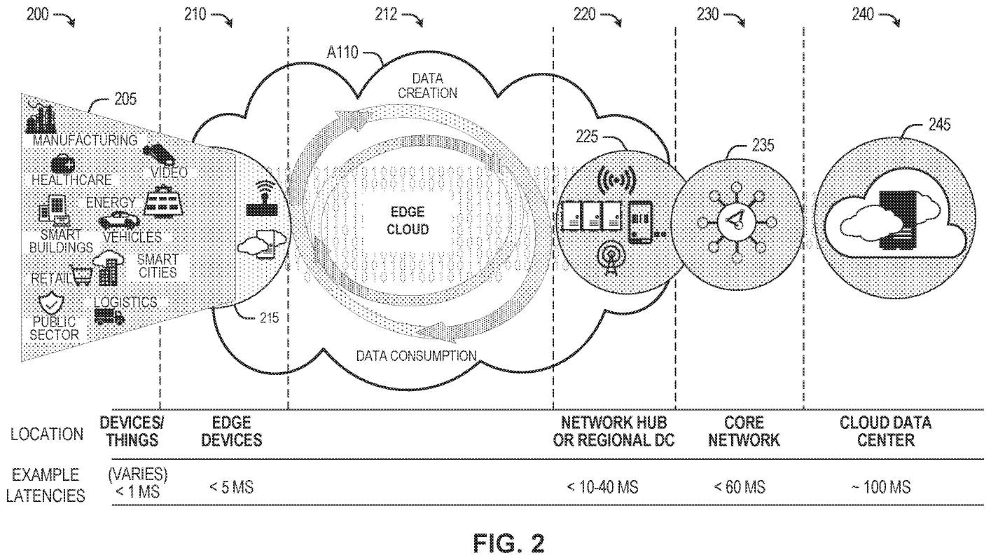

FIG. 2 illustrates operational layers among endpoints, an Edge cloud, and cloud computing environments. Specifically, FIG. 2 depicts examples of computational use cases 205, utilizing the Edge cloud 110 among multiple illustrative layers of network computing. The layers begin at an endpoint (devices and things) layer 200, which accesses the Edge cloud 110 to conduct data creation, analysis, and data consumption activities. The Edge cloud 110 may span multiple network layers, such as an Edge devices layer 210 having gateways, on-premise servers, or network equipment (nodes 215) located in physically proximate Edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the Edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the Edge devices layer 210, to even between 10 to 40 ms when communicating with nodes at the network access layer 220. Beyond the Edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close Edge”, “local Edge”, “near Edge”, “middle Edge”, or “far Edge” layers, relative to a network source and destination. For instance, from the perspective of the core network data center 235 or a cloud data center 245, a central office or content data network may be considered as being located within a “near Edge” layer (“near” to the cloud, having high latency values when communicating with the devices and endpoints of the use cases 205), whereas an access point, base station, on-premise server, or network gateway may be considered as located within a “far Edge” layer (“far” from the cloud, having low latency values when communicating with the devices and endpoints of the use cases 205). It will be understood that other categorizations of a particular network layer as constituting a “close”, “local”, “near”, “middle”, or “far” Edge may be based on latency, distance, number of network hops, or other measurable characteristics, as measured from a source in any of the network layers 200-240.

The various use cases 205 may access resources under usage pressure from incoming streams, due to multiple services utilizing the Edge cloud. To achieve results with low latency, the services executed within the Edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor, etc.).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to Service Level Agreement (SLA), the system as a whole (components in the transaction) may provide the ability to (1) understand the impact of the SLA violation, and (2) augment other components in the system to resume overall transaction SLA, and (3) implement steps to remediate.

Thus, with these variations and service features in mind, Edge computing within the Edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (e.g., Virtual Network Functions (VNFs), Function as a Service (FaaS), Edge as a Service (EaaS), standard processes, etc.), which cannot leverage conventional cloud computing due to latency or other limitations.

However, with the advantages of Edge computing comes the following caveats. The devices located at the Edge are often resource constrained and therefore there is pressure on usage of Edge resources. Typically, this is addressed through the pooling of memory and storage resources for use by multiple users (tenants) and devices. The Edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because Edge locations may be unmanned and may even need permissioned access (e.g., when housed in a third-party location). Such issues are magnified in the Edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an Edge computing system may be described to encompass any number of deployments at the previously discussed layers operating in the Edge cloud 110 (network layers 200-240), which provide coordination from client and distributed computing devices. One or more Edge gateway nodes, one or more Edge aggregation nodes, and one or more core data centers may be distributed across layers of the network to provide an implementation of the Edge computing system by or on behalf of a telecommunication service provider (“telco”, or “TSP”), internet-of-things service provider, cloud service provider (CSP), enterprise entity, or any other number of entities. Various implementations and configurations of the Edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the Edge computing system does not necessarily mean that such node or device operates in a client or agent/minion/follower role; rather, any of the nodes or devices in the Edge computing system refer to individual entities, nodes, or subsystems which include discrete or connected hardware or software configurations to facilitate or use the Edge cloud 110.

As such, the Edge cloud 110 is formed from network components and functional features operated by and within Edge gateway nodes, Edge aggregation nodes, or other Edge compute nodes among network layers 210-A230. The Edge cloud 110 thus may be embodied as any type of network that provides Edge computing and/or storage resources which are proximately located to radio access network (RAN) capable endpoint devices (e.g., mobile computing devices, IoT devices, smart devices, etc.), which are discussed herein. In other words, the Edge cloud 110 may be envisioned as an “Edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks, etc.) may also be utilized in place of or in combination with such 3GPP carrier networks.

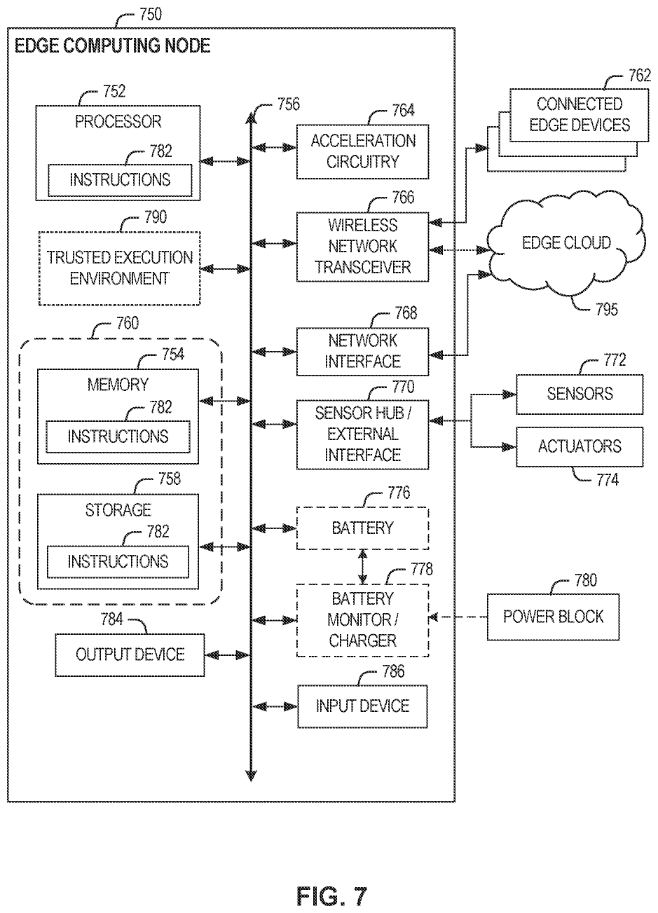

The network components of the Edge cloud 110 may be servers, multi-tenant servers, appliance computing devices, and/or any other type of computing devices. For example, the Edge cloud 110 may include an appliance computing device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., electromagnetic interference (EMI), vibration, extreme temperatures, etc.), and/or enable submergibility. Example housings may include power circuitry to provide power for stationary and/or portable implementations, such as alternating current (AC) power inputs, direct current (DC) power inputs, AC/DC converter(s), DC/AC converter(s), DC/DC converter(s), power regulators, transformers, charging circuitry, batteries, wired inputs, and/or wireless power inputs. Example housings and/or surfaces thereof may include or connect to mounting hardware to enable attachment to structures such as buildings, telecommunication structures (e.g., poles, antenna structures, etc.), and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, infrared or other visual thermal sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, rotors such as propellers, etc.) and/or articulating hardware (e.g., robot arms, pivotable appendages, etc.). In some circumstances, the sensors may include any type of input devices such as user interface hardware (e.g., buttons, switches, dials, sliders, microphones, etc.). In some circumstances, example housings include output devices contained in, carried by, embedded therein and/or attached thereto. Output devices may include displays, touchscreens, lights, light-emitting diodes (LEDs), speakers, input/output (I/O) ports (e.g., universal serial bus (USB)), etc. In some circumstances, Edge devices are devices presented in the network for a specific purpose (e.g., a traffic light), but may have processing and/or other capacities that may be utilized for other purposes. Such Edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 7. The Edge cloud 110 may also include one or more servers and/or one or more multi-tenant servers. Such a server may include an operating system and implement a virtual computing environment. A virtual computing environment may include a hypervisor managing (e.g., spawning, deploying, commissioning, destroying, decommissioning, etc.) one or more virtual machines, one or more containers, etc. Such virtual computing environments provide an execution environment in which one or more applications and/or other software, code, or scripts may execute while being isolated from one or more other applications, software, code, or scripts.

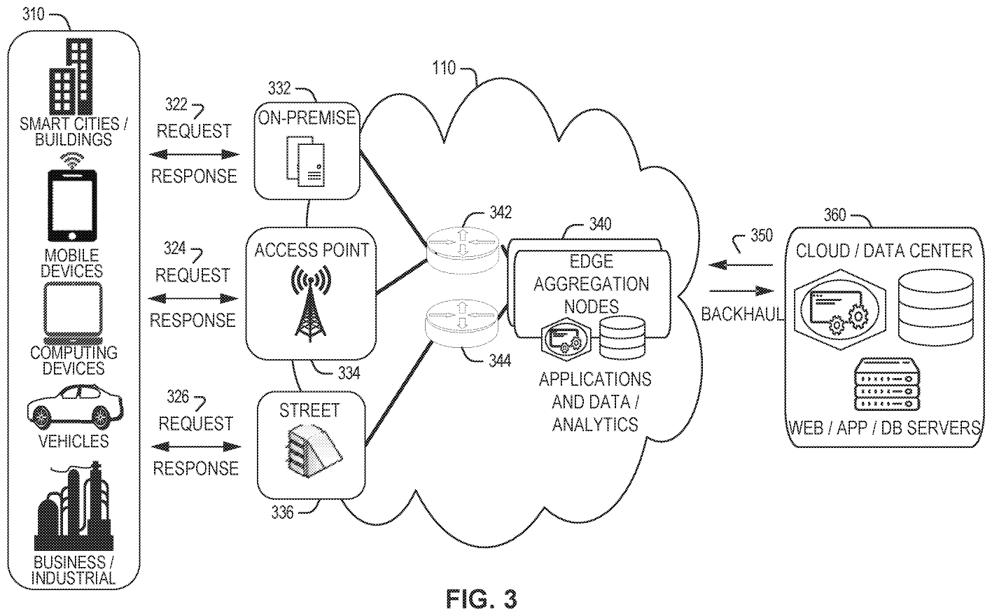

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., a cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the Edge cloud 110 to aggregate traffic and requests. Thus, within the Edge cloud 110, the TSP may deploy various compute and storage resources, such as at Edge aggregation nodes 340, to provide requested content. The Edge aggregation nodes 340 and other systems of the Edge cloud 110 are connected to a cloud or data center 360, which uses a backhaul network 350 to fulfill higher-latency requests from a cloud/data center for websites, applications, database servers, etc. Additional or consolidated instances of the Edge aggregation nodes 340 and the aggregation points 342, 344, including those deployed on a single server framework, may also be present within the Edge cloud 110 or other areas of the TSP infrastructure.

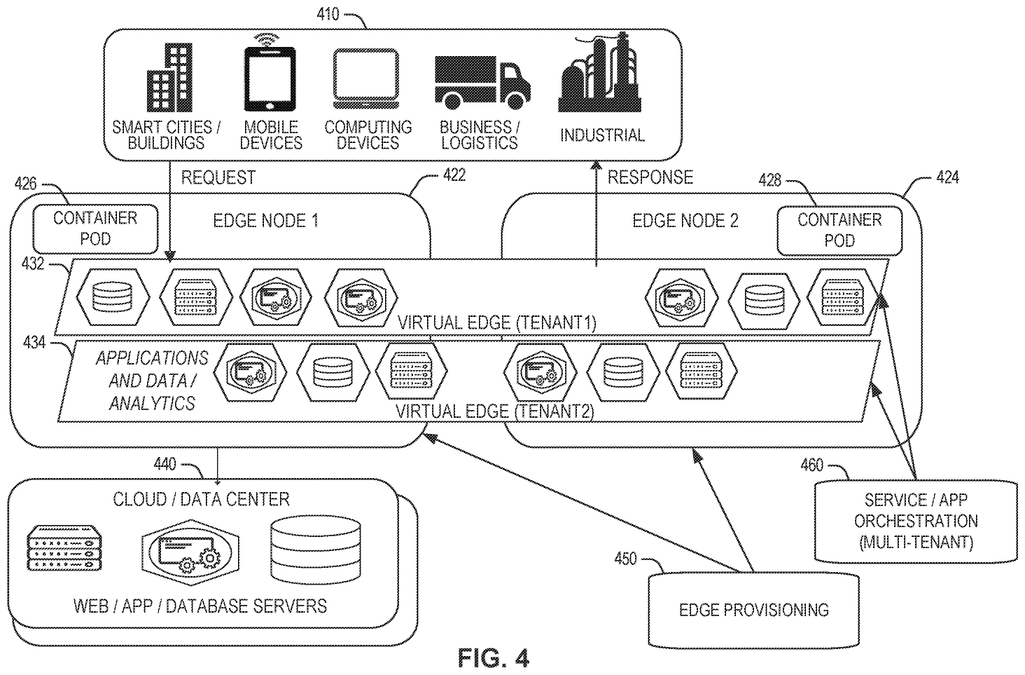

FIG. 4 illustrates deployment and orchestration for virtualized and container-based Edge configurations across an Edge computing system operated among multiple Edge nodes and multiple tenants (e.g., users, providers) which use such Edge nodes. Specifically, FIG. 4 depicts coordination of a first Edge node 422 and a second Edge node 424 in an Edge computing system 400, to fulfill requests and responses for various client endpoints 410 (e.g., smart cities/building systems, mobile devices, computing devices, business/logistics systems, industrial systems, etc.), which access various virtual Edge instances. Here, the virtual Edge instances 432, 434 provide Edge compute capabilities and processing in an Edge cloud, with access to a cloud/data center 440 for higher-latency requests for websites, applications, database servers, etc. However, the Edge cloud enables coordination of processing among multiple Edge nodes for multiple tenants or entities.

In the example of FIG. 4, these virtual Edge instances include: a first virtual Edge 432, offered to a first tenant (Tenant 1), which offers a first combination of Edge storage, computing, and services; and a second virtual Edge 434, offered to a second tenant (Tenant 2), which offers a second combination of Edge storage, computing, and services. The virtual Edge instances 432, 434 are distributed among the Edge nodes 422, 424, and may include scenarios in which a request and response are fulfilled from the same or different Edge nodes. The configuration of the Edge nodes 422, 424 to operate in a distributed yet coordinated fashion occurs based on Edge provisioning functions 450. The functionality of the Edge nodes 422, 424 to provide coordinated operation for applications and services, among multiple tenants, occurs based on orchestration functions 460.

It should be understood that some of the devices in 410 are multi-tenant devices where Tenant 1 may function within a tenant1 ‘slice’ while a Tenant 2 may function within a tenant2 slice (and, in further examples, additional or sub-tenants may exist; and each tenant may even be specifically entitled and transactionally tied to a specific set of features all the way day to specific hardware features). A trusted multi-tenant device may further contain a tenant specific cryptographic key such that the combination of key and slice may be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective Edge nodes 422, 424 may operate as security feature enforcement points for local resources allocated to multiple tenants per node. Additionally, tenant runtime and application execution (e.g., in instances 432, 434) may serve as an enforcement point for a security feature that creates a virtual Edge abstraction of resources spanning potentially multiple physical hosting platforms. Finally, the orchestration functions 460 at an orchestration entity may operate as a security feature enforcement point for marshalling resources along tenant boundaries.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes often use containers, FaaS engines, servlets, servers, or other computation abstraction that may be partitioned according to a DICE layering and fan-out structure to support a RoT context for each. Accordingly, the respective RoTs spanning devices 410, 422, and 440 may coordinate the establishment of a distributed trusted computing base (DTCB) such that a tenant-specific virtual trusted secure channel linking all elements end to end can be established.

Further, it will be understood that a container may have data or workload specific keys protecting its content from a previous Edge node. As part of migration of a container, a pod controller at a source Edge node may obtain a migration key from a target Edge node pod controller where the migration key is used to wrap the container-specific keys. When the container/pod is migrated to the target Edge node, the unwrapping key is exposed to the pod controller that then decrypts the wrapped keys. The keys may now be used to perform operations on container specific data. The migration functions may be gated by properly attested Edge nodes and pod managers (as described above).

In further examples, an Edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 4. For instance, an Edge computing system may be configured to fulfill requests and responses for various client endpoints from multiple virtual Edge instances (and, from a cloud or remote data center). The use of these virtual Edge instances may support multiple tenants and multiple applications (e.g., augmented reality (AR)/virtual reality (VR), enterprise applications, content delivery, gaming, compute offload, etc.) simultaneously. Further, there may be multiple types of applications within the virtual Edge instances (e.g., normal applications; latency sensitive applications; latency-critical applications; user plane applications; networking applications; etc.). The virtual Edge instances may also be spanned across systems of multiple owners at different geographic locations (or, respective computing systems and resources which are co-owned or co-managed by multiple owners).

For instance, each Edge node 422, 424 may implement the use of containers, such as with the use of a container “pod” 426, 428 providing a group of one or more containers. In a setting that uses one or more container pods, a pod controller or orchestrator is responsible for local control and orchestration of the containers in the pod. Various Edge node resources (e.g., storage, compute, services, depicted with hexagons) provided for the respective Edge slices 432, 434 are partitioned according to the needs of each container.

With the use of container pods, a pod controller oversees the partitioning and allocation of containers and resources. The pod controller receives instructions from an orchestrator (e.g., orchestrator 460) that instructs the controller on how best to partition physical resources and for what duration, such as by receiving key performance indicator (KPI) targets based on SLA contracts. The pod controller determines which container requires which resources and for how long in order to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, the pod controller may serve a security role that prevents assignment of resources until the right tenant authenticates or prevents provisioning of data or a workload to a container until an attestation result is satisfied.

Also, with the use of container pods, tenant boundaries can still exist but in the context of each pod of containers. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator 460 may provision an attestation verification policy to local pod controllers that perform attestation verification. If an attestation satisfies a policy for a first tenant pod controller but not a second tenant pod controller, then the second pod could be migrated to a different Edge node that does satisfy it. Alternatively, the first pod may be allowed to execute and a different shared pod controller is installed and invoked prior to the second pod executing.

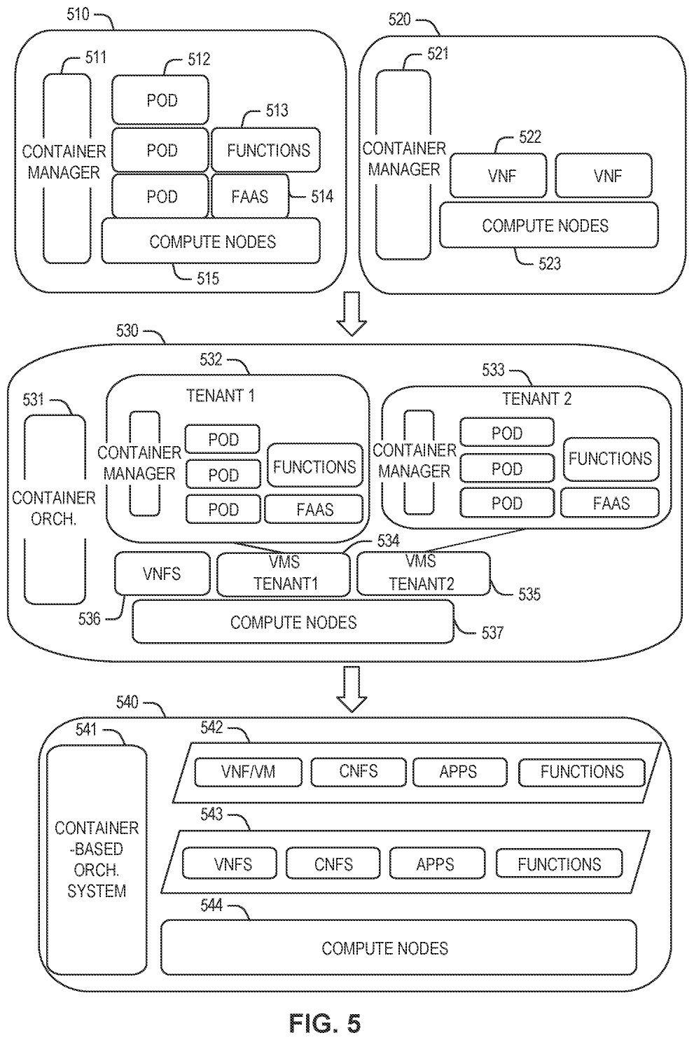

FIG. 5 illustrates additional compute arrangements deploying containers in an Edge computing system. As a simplified example, system arrangements 510, 520 depict settings in which a pod controller (e.g., container managers 511, 521, and container orchestrator 531) is adapted to launch containerized pods, functions, and FaaS instances through execution via compute nodes (515 in arrangement 510), or to separately execute containerized virtualized network functions through execution via compute nodes (523 in arrangement 520). This arrangement is adapted for use of multiple tenants in system arrangement 530 (using compute nodes 537), where containerized pods (e.g., pods 512), functions (e.g., functions 513, VNFs 522, 536), and functions-as-a-service instances (e.g., FaaS instance 514) are launched within virtual machines (e.g., VMs 534, 535 for tenants 532, 533) specific to respective tenants (aside the execution of virtualized network functions). This arrangement is further adapted for use in system arrangement 540, which provides containers 542, 543, or execution of the various functions, applications, and functions on compute nodes 544, as coordinated by an container-based orchestration system 541.

The system arrangements depicted in FIG. 5 provide an architecture that treats VMs, Containers, and Functions equally in terms of application composition (and resulting applications are combinations of these three ingredients). Each ingredient may involve use of one or more accelerator (e.g., FPGA, ASIC, etc.) components as a local backend. In this manner, applications can be split across multiple Edge owners, coordinated by an orchestrator.

In the context of FIG. 5, the pod controller/container manager, container orchestrator, and individual nodes may provide a security enforcement point. However, tenant isolation may be orchestrated where the resources allocated to a tenant are distinct from resources allocated to a second tenant, but Edge owners cooperate to ensure resource allocations are not shared across tenant boundaries. Or, resource allocations could be isolated across tenant boundaries, as tenants could allow “use” via a subscription or transaction/contract basis. In these contexts, virtualization, containerization, enclaves and hardware partitioning schemes may be used by Edge owners to enforce tenancy. Other isolation environments may include: bare metal (dedicated) equipment, virtual machines, containers, virtual machines on containers, or combinations thereof.

In further examples, aspects of software-defined or controlled silicon hardware, and other configurable hardware, may integrate with the applications, functions, and services an Edge computing system. Software defined silicon (SDSi) may be used to ensure the ability for some resource or hardware ingredient to fulfill a contract or service level agreement, based on the ingredient's ability to remediate a portion of itself or the workload (e.g., by an upgrade, reconfiguration, or provision of new features within the hardware configuration itself).

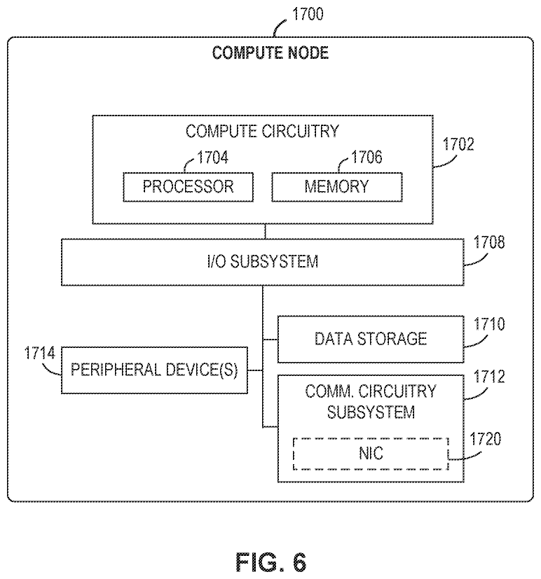

FIG. 6 provides an overview of example components for compute deployed at a compute node in an Edge computing system.

FIG. 7 provides a further overview of example components within a computing device in an Edge computing system.

In further examples, any of the compute nodes or devices discussed with reference to the present Edge computing systems and environment may be fulfilled based on the components depicted in FIGS. 6 and 7. Respective Edge compute nodes may be embodied as a type of device, appliance, computer, or other “thing” capable of communicating with other Edge, networking, or endpoint components. For example, an Edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 6, an Edge compute node 600 includes a compute engine (also referred to herein as “compute circuitry”) 602, an input/output (I/O) subsystem (also referred to herein as “I/O circuitry”) 608, data storage (also referred to herein as “data storage circuitry”) 610, a communication circuitry subsystem 612, and, optionally, one or more peripheral devices (also referred to herein as “peripheral device circuitry”) 614. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 600 may be embodied as any type of engine, device, or collection of devices capable of performing various compute functions. In some examples, the compute node 600 may be embodied as a single device such as an integrated circuit, an embedded system, a field-programmable gate array (FPGA), a system-on-a-chip (SOC), or other integrated system or device. In the illustrative example, the compute node 600 includes or is embodied as a processor (also referred to herein as “processor circuitry”) 604 and a memory (also referred to herein as “memory circuitry”) 606. The processor 604 may be embodied as any type of processor(s) capable of performing the functions described herein (e.g., executing an application). For example, the processor 604 may be embodied as a multi-core processor(s), a microcontroller, a processing unit, a specialized or special purpose processing unit, or other processor or processing/controlling circuit.

In some examples, the processor 604 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 604 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, storage disks, or AI hardware (e.g., GPUs, programmed FPGAs, or ASICs tailored to implement an AI model such as a neural network). Such an xPU may be designed to receive, retrieve, and/or otherwise obtain programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that an xPU, an SOC, a CPU, and other variations of the processor 604 may work in coordination with each other to execute many types of operations and instructions within and on behalf of the compute node 600.

The memory 606 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device (e.g., memory circuitry) is any number of block addressable memory devices, such as those based on NAND or NOR technologies (for example, Single-Level Cell (“SLC”), Multi-Level Cell (“MLC”), Quad-Level Cell (“QLC”), Tri-Level Cell (“TLC”), or some other NAND). In some examples, the memory device(s) includes a byte-addressable write-in-place three dimensional crosspoint memory device, or other byte addressable write-in-place non-volatile memory (NVM) devices, such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric transistor random access memory (FeTRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, a combination of any of the above, or other suitable memory. A memory device may also include a three-dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may include a transistor-less stackable cross point architecture in which memory cells sit at the intersection of word lines and bit lines and are individually addressable and in which bit storage is based on a change in bulk resistance. In some examples, all or a portion of the memory 606 may be integrated into the processor 604. The memory 606 may store various software and data used during operation such as one or more applications, data operated on by the application(s), libraries, and drivers.

In some examples, resistor-based and/or transistor-less memory architectures include nanometer scale phase-change memory (PCM) devices in which a volume of phase-change material resides between at least two electrodes. Portions of the example phase-change material exhibit varying degrees of crystalline phases and amorphous phases, in which varying degrees of resistance between the at least two electrodes can be measured. In some examples, the phase-change material is a chalcogenide-based glass material. Such resistive memory devices are sometimes referred to as memristive devices that remember the history of the current that previously flowed through them. Stored data is retrieved from example PCM devices by measuring the electrical resistance, in which the crystalline phases exhibit a relatively lower resistance value(s) (e.g., logical “0”) when compared to the amorphous phases having a relatively higher resistance value(s) (e.g., logical “1”).

Example PCM devices store data for long periods of time (e.g., approximately 10 years at room temperature). Write operations to example PCM devices (e.g., set to logical “0”, set to logical “1”, set to an intermediary resistance value) are accomplished by applying one or more current pulses to the at least two electrodes, in which the pulses have a particular current magnitude and duration. For instance, a long low current pulse (SET) applied to the at least two electrodes causes the example PCM device to reside in a low-resistance crystalline state, while a comparatively short high current pulse (RESET) applied to the at least two electrodes causes the example PCM device to reside in a high-resistance amorphous state.

In some examples, implementation of PCM devices facilitates non-von Neumann computing architectures that enable in-memory computing capabilities. Generally speaking, traditional computing architectures include a central processing unit (CPU) communicatively connected to one or more memory devices via a bus. As such, a finite amount of energy and time is consumed to transfer data between the CPU and memory, which is a known bottleneck of von Neumann computing architectures. However, PCM devices minimize and, in some cases, eliminate data transfers between the CPU and memory by performing some computing operations in-memory. Stated differently, PCM devices both store information and execute computational tasks. Such non-von Neumann computing architectures may implement vectors having a relatively high dimensionality to facilitate hyperdimensional computing, such as vectors having 10,000 bits. Relatively large bit width vectors enable computing paradigms modeled after the human brain, which also processes information analogous to wide bit vectors.

The compute circuitry 602 is communicatively coupled to other components of the compute node 600 via the I/O subsystem 608, which may be embodied as circuitry and/or components to facilitate input/output operations with the compute circuitry 602 (e.g., with the processor 604 and/or the main memory 606) and other components of the compute circuitry 602. For example, the I/O subsystem 608 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 608 may form a portion of a system-on-a-chip (SoC) and be incorporated, along with one or more of the processor 604, the memory 606, and other components of the compute circuitry 602, into the compute circuitry 602.

The one or more illustrative data storage devices/disks 610 may be embodied as one or more of any type(s) of physical device(s) configured for short-term or long-term storage of data such as, for example, memory devices, memory, circuitry, memory cards, flash memory, hard disk drives (HDDs), solid-state drives (SSDs), and/or other data storage devices/disks. Individual data storage devices/disks 610 may include a system partition that stores data and firmware code for the data storage device/disk 610. Individual data storage devices/disks 610 may also include one or more operating system partitions that store data files and executables for operating systems depending on, for example, the type of compute node 600.

The communication circuitry 612 may be embodied as any communication circuit, device, or collection thereof, capable of enabling communications over a network between the compute circuitry 602 and another compute device (e.g., an Edge gateway of an implementing Edge computing system). The communication circuitry 612 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 612 includes a network interface controller (NIC) 620, which may also be referred to as a host fabric interface (HFI). The NIC 620 may be embodied as one or more add-in-boards, daughter cards, network interface cards, controller chips, chipsets, or other devices that may be used by the compute node 600 to connect with another compute device (e.g., an Edge gateway node). In some examples, the NIC 620 may be embodied as part of a system-on-a-chip (SoC) that includes one or more processors, or included on a multichip package that also contains one or more processors. In some examples, the NIC 620 may include a local processor (not shown) and/or a local memory (not shown) that are both local to the NIC 620. In such examples, the local processor of the NIC 620 may be capable of performing one or more of the functions of the compute circuitry 602 described herein. Additionally, or alternatively, in such examples, the local memory of the NIC 620 may be integrated into one or more components of the client compute node at the board level, socket level, chip level, and/or other levels.

Additionally, in some examples, a respective compute node 600 may include one or more peripheral devices 614. Such peripheral devices 614 may include any type of peripheral device found in a compute device or server such as audio input devices, a display, other input/output devices, interface devices, and/or other peripheral devices, depending on the particular type of the compute node 600. In further examples, the compute node 600 may be embodied by a respective Edge compute node (whether a client, gateway, or aggregation node) in an Edge computing system or like forms of appliances, computers, subsystems, circuitry, or other components.

In a more detailed example, FIG. 7 illustrates a block diagram of an example of components that may be present in an Edge computing node 750 for implementing the techniques (e.g., operations, processes, methods, and methodologies) described herein. This Edge computing node 750 provides a closer view of the respective components of node 600 when implemented as or as part of a computing device (e.g., as a mobile device, a base station, server, gateway, etc.). The Edge computing node 750 may include any combination of the hardware or logical components referenced herein, and it may include or couple with any device usable with an Edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the Edge computing node 750, or as components otherwise incorporated within a chassis of a larger system.

The Edge computing device 750 may include processing circuitry in the form of a processor 752, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 752 may be a part of a system on a chip (SoC) in which the processor 752 and other components are formed into a single integrated circuit, or a single package, such as the Edison™ or Galileo™ SoC boards from Intel Corporation, Santa Clara, Calif. As an example, the processor 752 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 752 and accompanying circuitry may be provided in a single socket form factor, multiple socket form factor, or a variety of other formats, including in limited hardware configurations or configurations that include fewer than all elements shown in FIG. 7.

The processor 752 may communicate with a system memory 754 over an interconnect 756 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 758 may also couple to the processor 752 via the interconnect 756. In an example, the storage 758 may be implemented via a solid-state disk drive (SSDD). Other devices that may be used for the storage 758 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 758 may be on-die memory or registers associated with the processor 752. However, in some examples, the storage 758 may be implemented using a micro hard disk drive (HDD). Further, any number of new technologies may be used for the storage 758 in addition to, or instead of, the technologies described, such resistance change memories, phase change memories, holographic memories, or chemical memories, among others.

The components may communicate over the interconnect 756. The interconnect 756 may include any number of technologies, including industry standard architecture (ISA), extended ISA (EISA), peripheral component interconnect (PCI), peripheral component interconnect extended (PCIx), PCI express (PCIe), or any number of other technologies. The interconnect 756 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 756 may couple the processor 752 to a transceiver 766, for communications with the connected Edge devices 762. The transceiver 766 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected Edge devices 762. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 766 (or multiple transceivers) may communicate using multiple standards or radios for communications at a different range. For example, the Edge computing node 750 may communicate with close devices, e.g., within about 10 meters, using a local transceiver based on Bluetooth Low Energy (BLE), or another low power radio, to save power. More distant connected Edge devices 762, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 766 (e.g., a radio transceiver) may be included to communicate with devices or services in a cloud (e.g., an Edge cloud 795) via local or wide area network protocols. The wireless network transceiver 766 may be a low-power wide-area (LPWA) transceiver that follows the IEEE 802.15.4, or IEEE 802.15.4g standards, among others. The Edge computing node 750 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 766, as described herein. For example, the transceiver 766 may include a cellular transceiver that uses spread spectrum (SPA/SAS) communications for implementing high-speed communications. Further, any number of other protocols may be used, such as Wi-Fi® networks for medium speed communications and provision of network communications. The transceiver 766 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 768 may be included to provide a wired communication to nodes of the Edge cloud 795 or to other devices, such as the connected Edge devices 762 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 768 may be included to enable connecting to a second network, for example, a first NIC 768 providing communications to the cloud over Ethernet, and a second NIC 768 providing communications to other devices over another type of network.

Given the variety of types of applicable communications from the device to another component or network, applicable communications circuitry used by the device may include or be embodied by any one or more of components 764, 766, 768, or 770. Accordingly, in various examples, applicable means for communicating (e.g., receiving, transmitting, etc.) may be embodied by such communications circuitry.

The Edge computing node 750 may include or be coupled to acceleration circuitry 764, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific Edge computing tasks for service management and service operations discussed elsewhere in this document.

The interconnect 756 may couple the processor 752 to a sensor hub or external interface 770 that is used to connect additional devices or subsystems. The devices may include sensors 772, such as accelerometers, level sensors, flow sensors, optical light sensors, camera sensors, temperature sensors, global navigation system (e.g., GPS) sensors, pressure sensors, barometric pressure sensors, and the like. The hub or interface 770 further may be used to connect the Edge computing node 750 to actuators 774, such as power switches, valve actuators, an audible sound generator, a visual warning device, and the like.

In some optional examples, various input/output (I/O) devices may be present within or connected to, the Edge computing node 750. For example, a display or other output device 784 may be included to show information, such as sensor readings or actuator position. An input device 786, such as a touch screen or keypad may be included to accept input. An output device 784 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the Edge computing node 750. A display or console hardware, in the context of the present system, may be used to provide output and receive input of an Edge computing system; to manage components or services of an Edge computing system; identify a state of an Edge computing component or service; or to conduct any other number of management or administration functions or service use cases.

A battery 776 may power the Edge computing node 750, although, in examples in which the Edge computing node 750 is mounted in a fixed location, it may have a power supply coupled to an electrical grid, or the battery may be used as a backup or for temporary capabilities. The battery 776 may be a lithium ion battery, or a metal-air battery, such as a zinc-air battery, an aluminum-air battery, a lithium-air battery, and the like.

A battery monitor/charger 778 may be included in the Edge computing node 750 to track the state of charge (SoCh) of the battery 776, if included. The battery monitor/charger 778 may be used to monitor other parameters of the battery 776 to provide failure predictions, such as the state of health (SoH) and the state of function (SoF) of the battery 776. The battery monitor/charger 778 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 778 may communicate the information on the battery 776 to the processor 752 over the interconnect 756. The battery monitor/charger 778 may also include an analog-to-digital (ADC) converter that enables the processor 752 to directly monitor the voltage of the battery 776 or the current flow from the battery 776. The battery parameters may be used to determine actions that the Edge computing node 750 may perform, such as transmission frequency, mesh network operation, sensing frequency, and the like.

A power block 780, or other power supply coupled to a grid, may be coupled with the battery monitor/charger 778 to charge the battery 776. In some examples, the power block 780 may be replaced with a wireless power receiver to obtain the power wirelessly, for example, through a loop antenna in the Edge computing node 750. A wireless battery charging circuit, such as an LTC4020 chip from Linear Technologies of Milpitas, Calif., among others, may be included in the battery monitor/charger 778. The specific charging circuits may be selected based on the size of the battery 776, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 758 may include instructions 782 in the form of software, firmware, or hardware commands to implement the techniques described herein. Although such instructions 782 are shown as code blocks included in the memory 754 and the storage 758, it may be understood that any of the code blocks may be replaced with hardwired circuits, for example, built into an application specific integrated circuit (ASIC).

In an example, the instructions 782 provided via the memory 754, the storage 758, or the processor 752 may be embodied as a non-transitory, machine-readable medium 760 including code to direct the processor 752 to perform electronic operations in the Edge computing node 750. The processor 752 may access the non-transitory, machine-readable medium 760 over the interconnect 756. For instance, the non-transitory, machine-readable medium 760 may be embodied by devices described for the storage 758 or may include specific storage units such as storage devices and/or storage disks that include optical disks (e.g., digital versatile disk (DVD), compact disk (CD), CD-ROM, Blu-ray disk), flash drives, floppy disks, hard drives (e.g., SSDs), or any number of other hardware devices in which information is stored for any duration (e.g., for extended time periods, permanently, for brief instances, for temporarily buffering, and/or caching). The non-transitory, machine-readable medium 760 may include instructions to direct the processor 752 to perform a specific sequence or flow of actions, for example, as described with respect to the flowchart(s) and block diagram(s) of operations and functionality depicted above. As used herein, the terms “machine-readable medium” and “computer-readable medium” are interchangeable. As used herein, the term “non-transitory computer-readable storage medium” is expressly defined to include any type of computer-readable storage device and/or storage disk and to exclude propagating signals and to exclude transmission media.

Also in a specific example, the instructions 782 on the processor 752 (separately, or in combination with the instructions 782 of the machine readable medium 760) may configure execution or operation of a trusted execution environment (TEE) 790. In an example, the TEE 790 operates as a protected area accessible to the processor 752 for secure execution of instructions and secure access to data. Various implementations of the TEE 790, and an accompanying secure area in the processor 752 or the memory 754 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 750 through the TEE 790 and the processor 752.

While the illustrated examples of FIG. 6 and FIG. 7 include example components for a compute node and a computing device, respectively, examples disclosed herein are not limited thereto. As used herein, a “computer” may include some or all of the example components of FIGS. 6 and/or 7 in different types of computing environments. Example computing environments include Edge computing devices (e.g., Edge computers) in a distributed networking arrangement such that particular ones of participating Edge computing devices are heterogenous or homogeneous devices. As used herein, a “computer” may include a personal computer, a server, user equipment, an accelerator, etc., including any combinations thereof. In some examples, distributed networking and/or distributed computing includes any number of such Edge computing devices as illustrated in FIGS. 6 and/or 7, each of which may include different sub-components, different memory capacities, I/O capabilities, etc. For example, because some implementations of distributed networking and/or distributed computing are associated with particular desired functionality, examples disclosed herein include different combinations of components illustrated in FIGS. 6 and/or 7 to satisfy functional objectives of distributed computing tasks. In some examples, the term “compute node” or “computer” only includes the example processor 704, memory 706 and I/O subsystem 708 of FIG. 6. In some examples, one or more objective functions of a distributed computing task(s) rely on one or more alternate devices/structure located in different parts of an Edge networking environment, such as devices to accommodate data storage (e.g., the example data storage 710), input/output capabilities (e.g., the example peripheral device(s) 714), and/or network communication capabilities (e.g., the example NIC 720).

In some examples, computers operating in a distributed computing and/or distributed networking environment (e.g., an Edge network) are structured to accommodate particular objective functionality in a manner that reduces computational waste. For instance, because a computer includes a subset of the components disclosed in FIGS. 6 and 7, such computers satisfy execution of distributed computing objective functions without including computing structure that would otherwise be unused and/or underutilized. As such, the term “computer” as used herein includes any combination of structure of FIGS. 6 and/or 7 that is capable of satisfying and/or otherwise executing objective functions of distributed computing tasks. In some examples, computers are structured in a manner commensurate to corresponding distributed computing objective functions in a manner that downscales or upscales in connection with dynamic demand. In some examples, different computers are invoked and/or otherwise instantiated in view of their ability to process one or more tasks of the distributed computing request(s), such that any computer capable of satisfying the tasks proceed with such computing activity.

In the illustrated examples of FIGS. 6 and 7, computing devices include operating systems. As used herein, an “operating system” is software to control example computing devices, such as the example Edge compute node 700 of FIG. 6 and/or the example Edge compute node 750 of FIG. 7. Example operating systems include, but are not limited to consumer-based operating systems (e.g., Microsoft® Windows® 10, Google® Android® OS, Apple® Mac® OS, etc.). Example operating systems also include, but are not limited to industry-focused operating systems, such as real-time operating systems, hypervisors, etc. An example operating system on a first Edge compute node may be the same or different than an example operating system on a second Edge compute node. In some examples, the operating system invokes alternate software to facilitate one or more functions and/or operations that are not native to the operating system, such as particular communication protocols and/or interpreters. In some examples, the operating system instantiates various functionalities that are not native to the operating system. In some examples, operating systems include varying degrees of complexity and/or capabilities. For instance, a first operating system corresponding to a first Edge compute node includes a real-time operating system having particular performance expectations of responsivity to dynamic input conditions, and a second operating system corresponding to a second Edge compute node includes graphical user interface capabilities to facilitate end-user I/O.

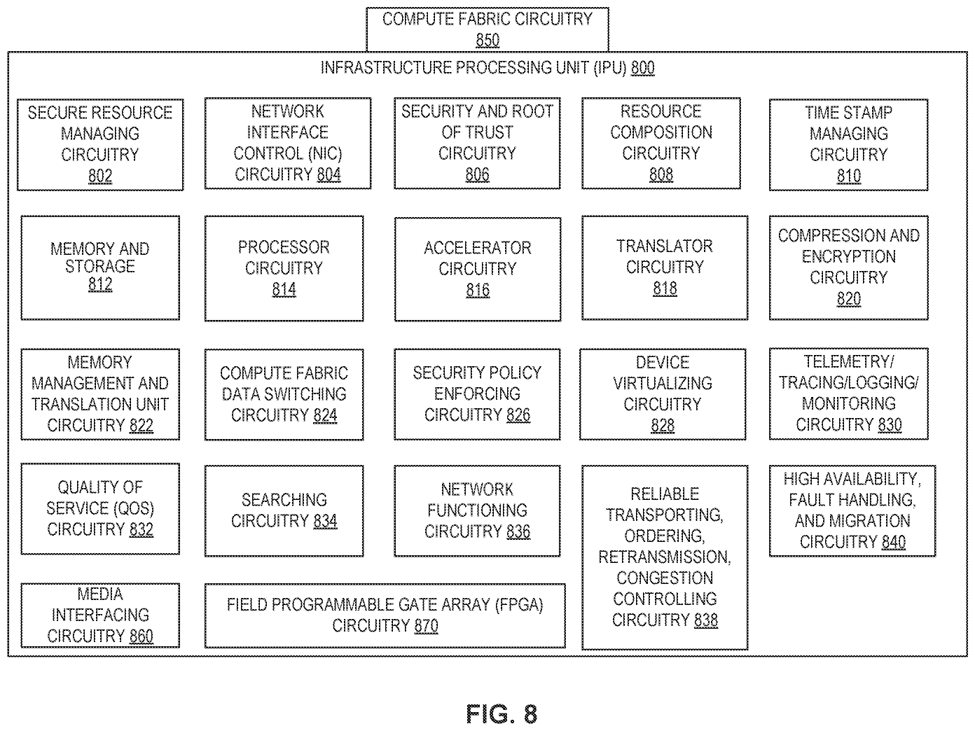

FIG. 8 is a schematic diagram of an example infrastructure processing unit (IPU). FIG. 8 depicts an example of an infrastructure processing unit (IPU). Different examples of IPUs disclosed herein enable improved performance, management, security and coordination functions between entities (e.g., cloud service providers), and enable infrastructure offload and/or communications coordination functions. As disclosed in further detail below, IPUs may be integrated with smart NICs and storage or memory (e.g., on a same die, system on chip (SoC), or connected dies) that are located at on-premises systems, base stations, gateways, neighborhood central offices, and so forth. Different examples of one or more IPUs disclosed herein can perform an application including any number of microservices, where each microservice runs in its own process and communicates using protocols (e.g., an HTTP resource API, message service or gRPC). Microservices can be independently deployed using centralized management of these services. A management system may be written in different programming languages and use different data storage technologies.

Furthermore, one or more IPUs can execute platform management, networking stack processing operations, security (crypto) operations, storage software, identity and key management, telemetry, logging, monitoring and service mesh (e.g., control how different microservices communicate with one another). The IPU can access an xPU to offload performance of various tasks. For instance, an IPU exposes XPU, storage, memory, and CPU resources and capabilities as a service that can be accessed by other microservices for function composition. This can improve performance and reduce data movement and latency. An IPU can perform capabilities such as those of a router, load balancer, firewall, TCP/reliable transport, a service mesh (e.g., proxy or API gateway), security, data-transformation, authentication, quality of service (QoS), security, telemetry measurement, event logging, initiating and managing data flows, data placement, or job scheduling of resources on an xPU, storage, memory, or CPU.

In the illustrated example of FIG. 8, the IPU 800 includes or otherwise accesses secure resource managing circuitry 802, network interface controller (NIC) circuitry 804, security and root of trust circuitry 806, resource composition circuitry 808, time stamp managing circuitry 810, memory and storage 812, processing circuitry 814, accelerator circuitry 816, and/or translator circuitry 818. Any number and/or combination of other structure(s) can be used such as but not limited to compression and encryption circuitry 820, memory management and translation unit circuitry 822, compute fabric data switching circuitry 824, security policy enforcing circuitry 826, device virtualizing circuitry 828, telemetry, tracing, logging and monitoring circuitry 830, quality of service circuitry 832, searching circuitry 834, network functioning circuitry (e.g., routing, firewall, load balancing, network address translating (NAT), etc.) 836, reliable transporting, ordering, retransmission, congestion controlling circuitry 838, and high availability, fault handling and migration circuitry 840 shown in FIG. 8. Different examples can use one or more structures (components) of the example IPU 800 together or separately. For example, compression and encryption circuitry 820 can be used as a separate service or chained as part of a data flow with vSwitch and packet encryption.

In some examples, IPU 800 includes a field programmable gate array (FPGA) 870 structured to receive commands from an CPU, XPU, or application via an API and perform commands/tasks on behalf of the CPU, including workload management and offload or accelerator operations. The illustrated example of FIG. 8 may include any number of FPGAs configured and/or otherwise structured to perform any operations of any IPU described herein.

Example compute fabric circuitry 850 provides connectivity to a local host or device (e.g., server or device (e.g., xPU, memory, or storage device)). Connectivity with a local host or device or smartNIC or another IPU is, in some examples, provided using one or more of peripheral component interconnect express (PCIe), ARM AXI, Intel® QuickPath Interconnect (QPI), Intel® Ultra Path Interconnect (UPI), Intel® On-Chip System Fabric (IOSF), Omnipath, Ethernet, Compute Express Link (CXL), HyperTransport, NVLink, Advanced Microcontroller Bus Architecture (AMBA) interconnect, OpenCAPI, Gen-Z, CCIX, Infinity Fabric (IF), and so forth. Different examples of the host connectivity provide symmetric memory and caching to enable equal peering between CPU, XPU, and IPU (e.g., via CXL.cache and CXL.mem).

Example media interfacing circuitry 860 provides connectivity to a remote smartNIC or another IPU or service via a network medium or fabric. This can be provided over any type of network media (e.g., wired or wireless) and using any protocol (e.g., Ethernet, InfiniBand, Fiber channel, ATM, to name a few).

In some examples, instead of the server/CPU being the primary component managing IPU 800, IPU 800 is a root of a system (e.g., rack of servers or data center) and manages compute resources (e.g., CPU, xPU, storage, memory, other IPUs, and so forth) in the IPU 800 and outside of the IPU 800. Different operations of an IPU are described below.

In some examples, the IPU 800 performs orchestration to decide which hardware or software is to execute a workload based on available resources (e.g., services and devices) and considers service level agreements and latencies, to determine whether resources (e.g., CPU, xPU, storage, memory, etc.) are to be allocated from the local host or from a remote host or pooled resource. In examples when the IPU 800 is selected to perform a workload, secure resource managing circuitry 802 offloads work to a CPU, xPU, or other device and the IPU 800 accelerates connectivity of distributed runtimes, reduce latency, CPU and increases reliability.

In some examples, secure resource managing circuitry 802 runs a service mesh to decide what resource is to execute workload, and provide for L7 (application layer) and remote procedure call (RPC) traffic to bypass kernel altogether so that a user space application can communicate directly with the example IPU 800 (e.g., IPU 800 and application can share a memory space). In some examples, a service mesh is a configurable, low-latency infrastructure layer designed to handle communication among application microservices using application programming interfaces (APIs) (e.g., over remote procedure calls (RPCs)). The example service mesh provides fast, reliable, and secure communication among containerized or virtualized application infrastructure services. The service mesh can provide critical capabilities including, but not limited to service discovery, load balancing, encryption, observability, traceability, authentication and authorization, and support for the circuit breaker pattern.

In some examples, infrastructure services include a composite node created by an IPU at or after a workload from an application is received. In some cases, the composite node includes access to hardware devices, software using APIs, RPCs, gRPCs, or communications protocols with instructions such as, but not limited, to iSCSI, NVMe-oF, or CXL.

In some cases, the example IPU 800 dynamically selects itself to run a given workload (e.g., microservice) within a composable infrastructure including an IPU, xPU, CPU, storage, memory, and other devices in a node.

In some examples, communications transit through media interfacing circuitry 860 of the example IPU 800 through a NIC/smartNIC (for cross node communications) or loopback back to a local service on the same host. Communications through the example media interfacing circuitry 860 of the example IPU 800 to another IPU can then use shared memory support transport between xPUs switched through the local IPUs. Use of IPU-to-IPU communication can reduce latency and jitter through ingress scheduling of messages and work processing based on service level objective (SLO).

For example, for a request to a database application that requires a response, the example IPU 800 prioritizes its processing to minimize the stalling of the requesting application. In some examples, the IPU 800 schedules the prioritized message request issuing the event to execute a SQL query database and the example IPU constructs microservices that issue SQL queries and the queries are sent to the appropriate devices or services.

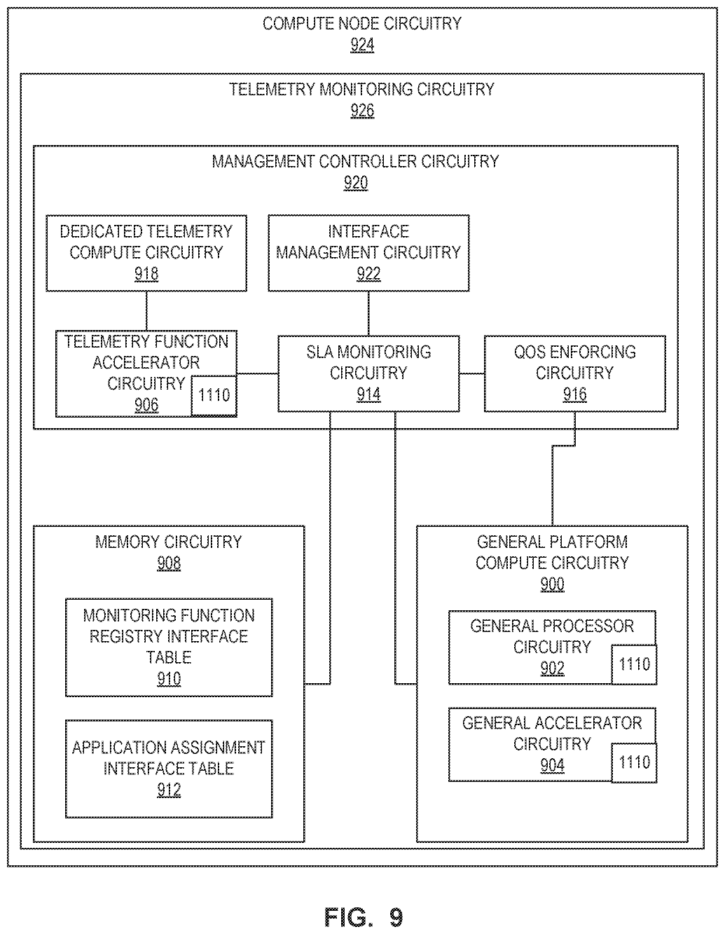

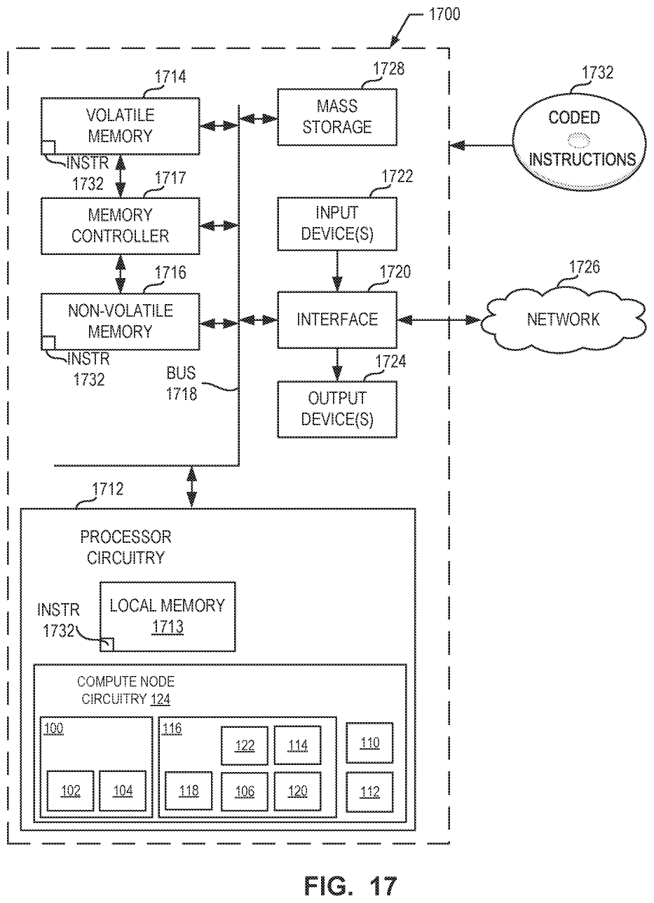

FIG. 9 is a schematic illustration of an example apparatus to implement edge-scalable adaptive-grained monitoring and telemetry processing for multi-QoS services. In the illustrated example in FIG. 9, a general platform compute circuitry 900 is shown. The example general platform compute circuitry 900 includes a general processor circuitry 902. In different examples, the general processor circuitry 902 may include one or more central processing units (CPUs), one or more graphics processing units (GPUs), one or more application specific integrated circuits (ASICs), and one or more of any number of other processors. FIG. 17 includes a more detailed description of general processor circuitry 902 in the details of processing circuitry 1612.

Returning to FIG. 9, the example general platform compute circuitry 900 includes a general accelerator circuitry 904. In different examples, the general accelerator circuitry 904 may include one or more accelerator units designed to accelerate one or more specific processes. The example general accelerator circuitry 904 is different from the example general processor circuitry 902 in that the accelerator(s) located in the general accelerator circuitry 904 are meant for more specific applications, tasks, and processes when compared to the example general processor circuitry 902 that is capable of executing general purpose instructions (e.g., instructions that perform functions in software applications running on an operating system). Additionally, the term “general” in reference to both the general processor circuitry 902 and the general accelerator circuitry 904 simply is meant to distinguish from dedicated telemetry function accelerator circuitry 906, discussed in detail further below.

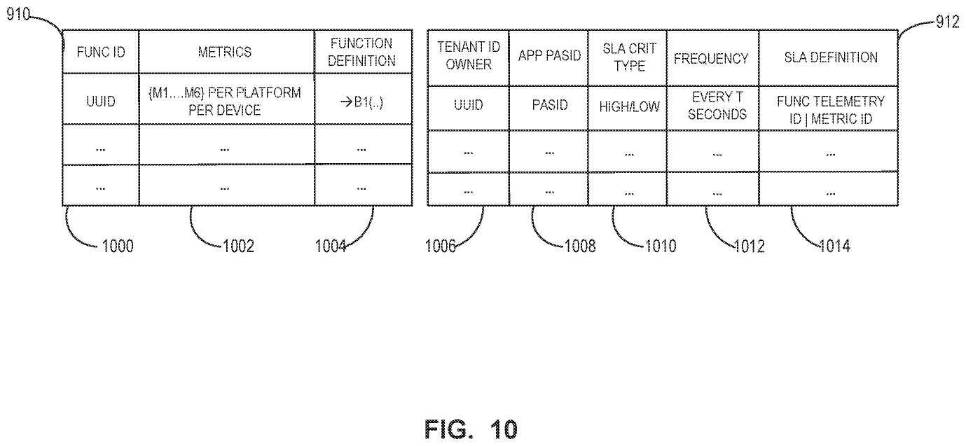

In the illustrated example in FIG. 9, memory circuitry 908 is present. The example memory circuitry 908 may be dynamic random access memory (DRAM), non-volatile memory, a cache, a series of registers, one or more storage buffers integrated as a portion of a processor circuitry, or any other type of memory storage capable of storing information. In the illustrated example in FIG. 9, there are at least two interfaces stored in memory circuitry 908: monitoring function registry interface data structure 910 and application assignment interface data structure 912. In other examples, the monitoring function registry interface data structure 910 and the application assignment interface data structure 912 are each stored in separate memory circuitries. In yet other examples, one or both of the monitoring function registry interface data structure 910 and the application assignment interface data structure 912 are implemented in hardware defined registers or other hardware circuitries due to the important nature and speed with which these interfaces may be required to function. In some examples, one or more processes in the system cause the storage of the monitoring function registry interface data structure 910 and the application assignment interface data structure 912 (i.e., create the interfaces as described in FIG. 10 and then utilize an operating system call, a storage controller call, or another “store” function to have the monitoring function registry interface data structure 910 and the application assignment interface data structure 912 written to a memory, such as memory circuitry 908. For example, the SLA monitoring circuitry 914 may initialize both interfaces and send a call to an operating system or another system service to cause the storage. In other examples, the monitoring function registry interface data structure 910 and the application assignment interface data structure 912 are pure software instantiations (e.g., virtual containers) and not implemented in circuitry.

The example monitoring function registry interface data structure 910 lists monitoring functions. In some examples, a monitoring function is specified (e.g., defined) by an identifier, a definition of the monitoring function, and a list of telemetry metrics (e.g., telemetry information, a telemetry metric list) to be collected by the monitoring function. In some examples, telemetry metrics may include compute unit utilization (e.g., general compute, accelerator compute, and/or dedicated accelerator compute unit utilization), application priority level, monitoring function priority level, power consumption utilization, time of day, or any other known metric that could be utilized to provide information.

FIG. 10 includes an illustration of the detail in the example monitoring function registry interface data structure 910. Each row in the example monitoring function registry interface data structure 910 is representative of functions performed by the telemetry monitoring circuitry 926. Each row in the example monitoring function registry interface data structure 910 has a function ID 1000. In some examples, the function ID 1000 is a universal unique ID (UUID) that is utilized by a service stack (e.g., a list of services running on a device that includes the monitoring function registry interface data structure 910. In some examples, the service stack utilizes the UUID to tie the listed monitoring function to a particular application (e.g., task, service, function) on the device.

Next, each row in the example monitoring function registry interface data structure 910 includes a listed set of metrics 1002. The listed set of metrics 1002 includes the specified set of telemetry information to be collected as inputs. In some examples, the listed set of metrics 1002 include telemetry information regarding the hardware and/or software of the device/platform itself (e.g., the same device storing the example monitoring function registry interface data structure 910). In other examples, the listed set of metrics 1002 include telemetry information regarding the hardware and/or software of other devices connected to the device/platform. In yet other examples, the listed set of metrics 1002 include telemetry information regarding both the hardware and/or software of the device itself and other devices connected to the device itself. In some examples, a device can either be a discrete device (e.g., connected via a PCIe or CXL interface) or integrated into a processor/accelerator circuitry (e.g., integrated into a CPU). For example, a crypto accelerator may be integrated into a CPU. Additionally, in some examples, any device or element in any system may have its own SLA.

The example monitoring function registry interface data structure 910 also includes a function definition 1004. In some examples, the function definition 1004 is a descriptor, pointer, etc. for the monitoring function to be computed. In some examples, the monitoring function to be computed is a function defined by one or more operations to compute/retrieve the list of metrics 1002 and, therefore, the function definition 1004 points to the one or more operations needed to compute the metrics. In other examples, the function definition 1004 points to more complex algorithm represented as a bit-stream (or similar information) to be executed in a compute element (e.g., processor circuitry core(s), accelerator(s), or specialized logic). In yet other examples, the monitoring function or sub-functions (e.g., the operations that retrieve the information including the list of metrics 1002) that the monitoring function invokes for metrics collection may additionally include function calls to deliver expedited (e.g., out-of-band) codes, signals, etc. The expedited codes/signals may indicate possible SLA violations that have been detected or predicted (e.g., a prediction based on a trend of metric heading towards an SLA violation). In some examples, the function definition may also include QoS actions to be performed in response to an SLA violation.

FIG. 10 also includes an illustration of the detail in the example application assignment interface data structure 912. In some examples, the application assignment interface data structure 912 is to list application instances as running/present/available/etc. Each row in the example application assignment interface data structure 912 is representative of an application instance to potentially be monitored by one or more monitoring functions. Each row in the example application assignment interface data structure 912 has a tenant ID owner 1006. In some examples, the tenant ID owner 1006 is a UUID that links a function ID in the example monitoring function registry interface data structure 910 with an application to be monitored in the application assignment interface data structure 912. To complete the link, each row in the example application assignment interface data structure 912 also includes an application process address space (App PASID) 1008 that identifies the software instance (e.g., the task, service, function, application to be monitored) linked to the UUID monitoring function. In some examples, the App PASID 1008 and the UUID 1006 listed in each entry in the application assignment interface data structure 912 enable the link between the listed monitoring function and the listed application.

In the illustrated example of FIG. 10, the example application assignment interface data structure 912 also includes an SLA criticality type 1010. The example SLA criticality type 1010 defines the criticality (e.g., importance) of the application (e.g., task/service/function/etc.) instance being monitored. For example, there may be three defined criticality levels of the application instance with three different requirements of how monitoring is to be performed based on the criticality type:
Low criticality: No acceleration is needed to compute the monitoring function and resources may be redistributed to enhance the monitoring of other services/applications.
Medium criticality: Acceleration of the computation of the monitoring function is optional and will be utilized if the acceleration resources can be spared from other services/applications (based on the criticality levels of the other services/applications.
High criticality: Acceleration or expedited operation of the computation of the monitoring function is needed for scalable and/or real-time functionality.

In other examples, any other number of criticality types may be added or removed to create a more fine-grained or coarse-grained approach to utilizing an SLA criticality type (e.g., there may be 10 levels of criticality in a certain scenario and another scenario may have only a single criticality level. Additionally, in some examples, the number of discrete criticality levels may have other types of defined values, different from a level of criticality.

In the illustrated example of FIG. 10, the application assignment interface data structure 912 also includes a frequency 1012. In some examples, the frequency 1012 signifies how frequently the monitoring function should be executed to monitor the application. For example, a first monitoring function may be executed once every 10 micro-seconds, a second monitoring function may be executed once every millisecond, a third monitoring function may be executed once every second, and a fourth monitoring function may be executed continuously to monitor an application in a continuous real-time mode.

In the illustrated example of FIG. 10, the application assignment interface data structure 912 also includes the SLA definition 1014. The example SLA definition 1014 defines which actions the monitoring function would take or how the monitoring function would trigger corrective actions. For example, the SLA definition 1014 may include a function telemetry ID or metric ID. In some examples, the SLA definition 1014 may include a pointer to a QoS logic to take corrective action. In some examples, the SLA definition 1014 may include one or more operations (or pointers to operations) to deliver a user-level interrupt (ULI) or another type of interrupt to the software stack of the device to launch a software callback. In other examples, the SLA definition 1014 can include one or more additional functional items to be completed to define the metric to take, to define the thresholds of the metric, and/or to define the options to trigger in the event the metric reaches a threshold level.

Although the example monitoring function registry interface data structure 910 and the application assignment interface data structure 912 are shown as a data structure with multiple rows for multiple entries in FIG. 10, it should be appreciated that, in some examples, each data structure, when existing, may have a single entry.

Returning to FIG. 9, an example SLA monitoring circuitry 914 is shown. In some examples, the SLA monitoring circuitry 914 is responsible for implementing the example monitoring function registry interface data structure 910 and the example application assignment interface data structure 912. For example, the SLA monitoring circuitry 914 may initialize and set up the example monitoring function registry interface data structure 910 and the example application assignment interface data structure 912 at system boot time. In other examples, another entity (e.g., a remote administrator agent) initializes the example monitoring function registry interface data structure 910 and the example application assignment interface data structure 912.

In some examples, the SLA monitoring circuitry 914 is responsible for adding new monitoring functions, as they become available, to the monitoring function registry interface data structure 910 and is responsible for adding new application instances, as they are created, to the application assignment interface data structure 912. In some examples, the SLA monitoring circuitry 914 links the monitoring functions to the application instances. In different examples, each application instance can be linked to zero, one, or more than one monitoring function, based on the monitoring needs of the application instance.

To link a monitoring function to a particular application (e.g., service/task/function/etc), the example SLA monitoring circuitry 914 instantiates a monitoring function UUID (1000 in FIG. 10) to an application PASID (1008 in FIG. 10). In some examples, if the application is a high criticality/priority application (or the defined monitoring function itself, by definition of what it monitors, is a high priority monitoring function), then the SLA monitoring circuitry 914 instantiates the monitoring function into one of the accelerated compute units available (e.g., general accelerator circuitry 904).

In some examples, one or more of the functional blocks described in FIG. 9 may include the functions of an IPU (as described in the discussion of FIG. 8 above). In some examples, the IPU-style functional blocks of FIG. 9 may communicate with each other by way of IPU-to-IPU messaging. IPU-based messaging communications among the functional blocks of FIG. 9 may schedule messages and work processing based on one or more service level objectives (SLO).

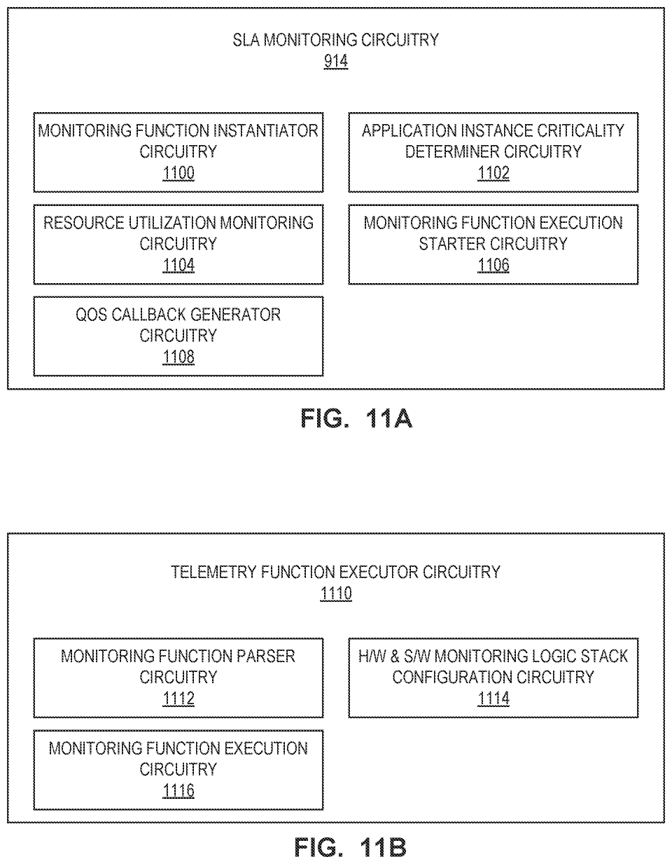

FIG. 11A is a schematic illustration of an example apparatus including detailed circuitry implemented within the SLA monitoring logic circuitry 914. The example SLA monitoring logic includes a monitoring function instantiator circuitry 1100 to instantiate the monitoring function for an application instance in a hardware and software monitoring logic stack. In some examples, the hardware and software monitoring logic stack includes a stack of hardware and software layers on the device that at a high level includes the software application to be monitored, at lower layers of the stack includes the operating system and the operating system kernel the software application runs on, and at further lower layers of the stack includes the hardware the operating system runs/exists on (e.g., the general platform compute circuitry 900 and the memory circuitry 908 that make up portions of the device). The “hardware and software monitoring logic stack” simply defines that entire stack of hardware and software logic that is to be monitored by the monitoring function to determine if the SLA(s) is being adhered to or violated.

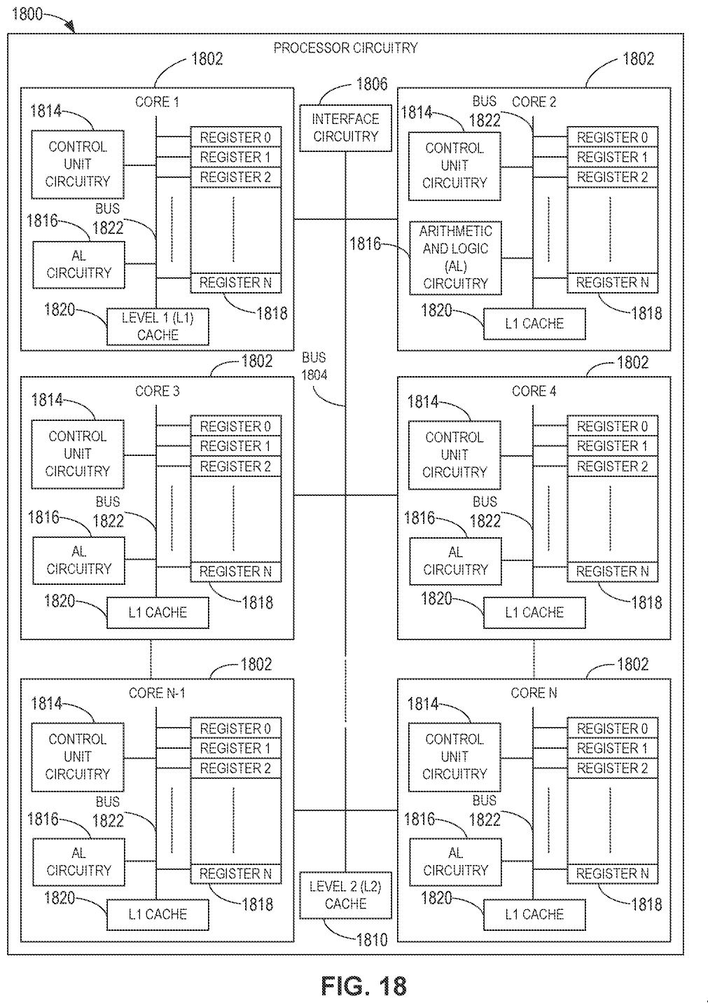

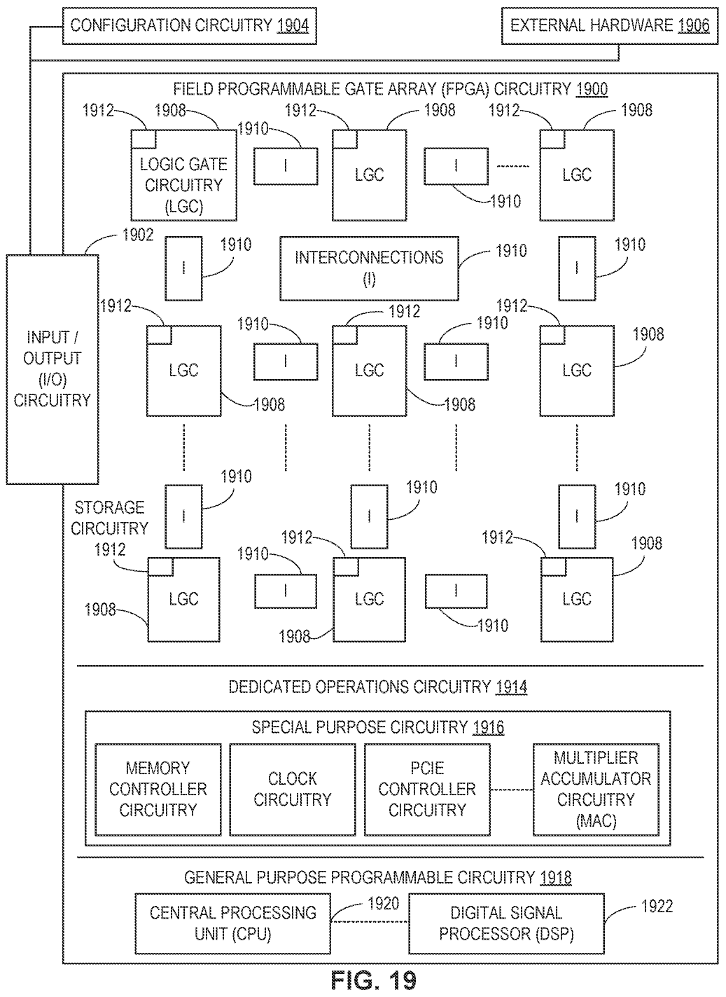

In some examples, the apparatus includes means for instantiating the monitoring function for an application instance in a hardware and software monitoring logic stack. For example, the means for instantiating may be implemented by the monitoring function instantiator circuitry 1100. In some examples, the monitoring function instantiator circuitry 1100 may be implemented by machine executable instructions such as that implemented by at least block 1100 of FIG. 11A executed by processor circuitry, which may be implemented by the example processor circuitry 1712 of FIG. 17, the example processor circuitry 1800 of FIG. 18, and/or the example Field Programmable Gate Array (FPGA) circuitry 1900 of FIG. 19. In other examples, the monitoring function instantiator circuitry 1100 is implemented by other hardware logic circuitry, hardware implemented state machines, and/or any other combination of hardware, software, and/or firmware. For example, the monitoring function instantiator circuitry 1100 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the example SLA monitoring circuitry 914 includes an application instance criticality determiner circuitry 1102 to determine the criticality (e.g., priority) level of the application to be monitored. The example application instance criticality determiner circuitry 1102 may use one or more processes to determine the criticality level of the application. In some examples, the criticality level is known based on the SLA criticality type 1010 information in the application assignment interface data structure 912, per application instance (app PASID 1008) listed. In other examples, an application criticality level is known one or more other methods, such as a pre-determined OS-based criticality list or other processes.

In some examples, the apparatus includes means for determining the application instance criticality level. For example, the means for determining may be implemented by the application instance criticality determiner circuitry 1102. In some examples, the application instance criticality determiner circuitry 1102 may be implemented by machine executable instructions such as that implemented by at least block 1102 of FIG. 11A executed by processor circuitry, which may be implemented by the example processor circuitry 1712 of FIG. 17, the example processor circuitry 1800 of FIG. 18, and/or the example Field Programmable Gate Array (FPGA) circuitry 1900 of FIG. 19. In other examples, the application instance criticality determiner circuitry 1102 is implemented by other hardware logic circuitry, hardware implemented state machines, and/or any other combination of hardware, software, and/or firmware. For example, the application instance criticality determiner circuitry 1102 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the example SLA monitoring circuitry 914 includes a resource utilization monitoring circuitry 1104 to monitor the usage/utilization of compute resources (e.g., compute units capable of providing the monitoring and compute required to execute a monitoring function). In some examples, if the application is determined to be less than a high criticality/priority application (e.g., a medium priority application), then the resource utilization monitoring circuitry 1104 will monitor the compute units (e.g., general processor circuitry 902, general accelerator circuitry 902, and/or telemetry function accelerator circuitry 906 plus the dedicated telemetry compute circuitry 918) used by one or more non-high criticality services. When there are enough resources to execute the monitoring function, the example SLA monitoring circuitry 914 through the use of the monitoring function instantiator circuitry 1100 will instantiate the monitoring function into one (or more) of the compute units to retrieve and calculate the telemetry data. In some examples, the resource utilization monitoring circuitry 1104 continuously monitors the compute unit resources and can prioritize and de-prioritize the monitoring function several times as resource constraints dynamically change.

In some examples, the resource utilization monitoring circuitry 1104 utilizes Top-down Microarchitecture Analysis Methods (TMAM), and the resulting metrics, to identify whether a given compute unit resource is fully utilized or is being utilized by a lower priority service/application than the monitoring function. If the resources are or become available, the monitoring function instantiator circuitry 1100 instantiates the monitoring function in the software stack to begin/resume monitoring and/or computing telemetry data.

In some examples, the resource utilization monitoring circuitry 1104 monitors a utilization rate of a platform (e.g., compute node) resource. If the utilization rate of the resource is below a maximum threshold rate, the monitoring function execution starter circuitry 1106 may cause at least a portion of the general platform compute circuitry to execute the monitoring function.

In some examples, the monitoring function instantiator circuitry 1100 moves the monitoring function to lower priority software stacks as they become available, allowing the freeing resources in higher priority software stacks. If/when this occurs, the monitoring function instantiator circuitry 1100 releases the monitoring function resources from the medium-priority software stack (and potentially release any resources associated with QoS logic as well) to allow such resources to be made available to other higher priority functions.

In some examples, the apparatus includes means for monitoring the utilization of the device resources/compute units. For example, the means for monitoring may be implemented by the resource utilization monitoring circuitry 1104. In some examples, the resource utilization monitoring circuitry 1104 may be implemented by machine executable instructions such as that implemented by at least block 1104 of FIG. 11A executed by processor circuitry, which may be implemented by the example processor circuitry 1712 of FIG. 17, the example processor circuitry 1800 of FIG. 18, and/or the example Field Programmable Gate Array (FPGA) circuitry 1900 of FIG. 19. In other examples, the resource utilization monitoring circuitry 1104 is implemented by other hardware logic circuitry, hardware implemented state machines, and/or any other combination of hardware, software, and/or firmware. For example, the resource utilization monitoring circuitry 1104 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the example SLA monitoring circuitry 914 includes a monitoring function execution starter (e.g., causer) circuitry 1106 that causes the execution of each monitoring function being utilized to monitor one or more applications every N units of time (e.g., the frequency of the monitoring). In some examples, the monitoring function execution starter circuitry 1106 manages a timer (e.g., initiate/set/reset) to count down the frequency of time (e.g., every N units). In some examples, the monitoring function execution starter circuitry 1106 causes the monitoring function to begin execution every time the timer reaches zero, and then the timer is reset.

In FIG. 11A, the SLA monitoring circuitry 914 additionally includes a QoS callback generator circuitry 1108 to generate any enforcement callbacks to a QoS enforcing circuitry 916 in response to a violation of the SLA (e.g., the definition of the SLA). In some examples, the SLA monitoring circuitry 914 will provide the ID of the monitoring function, a current set of values of the telemetry metrics associated with the monitoring function, and any result of the execution of the monitoring function (e.g., a telemetry data exceeded a threshold in the SLA). In some examples, the SLA monitoring circuitry 914 causes the monitoring function to execute in the hardware and software monitoring logic stack.

In some examples, the apparatus includes means for causing the monitoring function to execute in the hardware and software monitoring logic stack. For example, the means for causing may be implemented by the monitoring function execution starter circuitry 1106. In some examples, the monitoring function execution starter circuitry 1106 may be implemented by machine executable instructions such as that implemented by at least block 1106 of FIG. 11A executed by processor circuitry, which may be implemented by the example processor circuitry 1712 of FIG. 17, the example processor circuitry 1800 of FIG. 18, and/or the example Field Programmable Gate Array (FPGA) circuitry 1900 of FIG. 19. In other examples, the monitoring function execution starter circuitry 1106 is implemented by other hardware logic circuitry, hardware implemented state machines, and/or any other combination of hardware, software, and/or firmware. For example, the monitoring function execution starter circuitry 1106 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the apparatus includes means for generating a quality of service (QoS) enforcement callback in response to a violation of the SLA definition. For example, the means for generating may be implemented by the QoS callback generator circuitry 1108. In some examples, the QoS callback generator circuitry 1108 may be implemented by machine executable instructions such as that implemented by at least block 1108 of FIG. 11A executed by processor circuitry, which may be implemented by the example processor circuitry 1712 of FIG. 17, the example processor circuitry 1800 of FIG. 18, and/or the example Field Programmable Gate Array (FPGA) circuitry 1900 of FIG. 19. In other examples, the QoS callback generator circuitry 1108 is implemented by other hardware logic circuitry, hardware implemented state machines, and/or any other combination of hardware, software, and/or firmware. For example, the QoS callback generator circuitry 1108 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In the illustrated example in FIG. 9, the QoS enforcing circuitry 916 receives callbacks from the SLA monitoring circuitry 914 and performs one or more actions associated with the callback. For example, a callback to handle an SLA violation or a predicted impending SLA violation (due to a trend in the telemetry data) may cause the QoS enforcing circuitry 916 to send signals to the general platform compute circuitry 900 (e.g., the general processor circuitry 902 and/or the general accelerator circuitry 904 compute units) to reprioritize the application being monitored because it is not receiving the percentage of one or more compute resources is was to be provided or the percentage of time of one or more compute resources. The example QoS enforcing circuitry 916 may cause the general platform compute circuitry 900 (e.g., the general processor circuitry 902 and/or the general accelerator circuitry 904 compute units) to move the application to a higher software stack priority level and/or deprioritize other applications to provide more resources to the application in question.

In some examples, the apparatus includes means for performing a QoS action in response to receiving a QoS callback of a violation to an SLA. For example, the means for generating may be implemented by the QoS enforcing circuitry 916. In some examples, the QoS enforcing circuitry 916 may be implemented by machine executable instructions such as that implemented by at least block 916 of FIG. 9 executed by processor circuitry, which may be implemented by the example processor circuitry 1712 of FIG. 17, the example processor circuitry 1800 of FIG. 18, and/or the example Field Programmable Gate Array (FPGA) circuitry 1900 of FIG. 19. In other examples, the QoS enforcing circuitry 916 is implemented by other hardware logic circuitry, hardware implemented state machines, and/or any other combination of hardware, software, and/or firmware. For example, the QoS enforcing circuitry 916 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In the illustrated example in FIG. 9, the telemetry function accelerator circuitry 906 may include dedicated telemetry compute circuitry 918 for monitoring/retrieving/computing telemetry function data. This is separate from the general processor circuitry 902 and the general accelerator circuitry 904 in the device as the dedicated telemetry compute circuitry is not utilized for any other type of functionality and allows for uninterrupted dedicated telemetry computation to help with high priority monitoring functions. In some examples, the telemetry function accelerator circuitry 906 provides the computed telemetry results to the SLA monitoring circuitry 914 to assist in monitoring the applications.

In the illustrated example in FIG. 9, the SLA monitoring circuitry 914, the QoS enforcing circuitry 916, the telemetry function accelerator circuitry 906, and the dedicated telemetry compute circuitry 918 are located in a management controller circuitry 920. In some examples, the management controller circuitry 920 is a board management controller chip that is located on a motherboard of the device but discrete from the general platform compute circuitry 900. In other examples, the management controller circuitry 920 is integrated into the general platform compute circuitry 900. In some examples, an interface management circuitry 922 provides a communication link from other circuitry on the device to the management controller circuitry 920 (and the SLA monitoring circuitry 914 integrated in the management controller circuitry 920).

In some examples, the management controller circuitry 920, the general platform compute circuitry 900, the memory circuitry 908, and all circuitries illustrated in FIG. 9 as being within those circuitries (920, 900, and 908) are located within a telemetry monitoring circuitry 926 that is more generally at least a portion of a compute node circuitry 924. The compute node circuitry 924 may be in any form of compute node known and described above in reference to FIG. 7.

FIG. 11B is a schematic illustration of an example apparatus including detailed telemetry function executor circuitry implemented within the general processor circuitry 902, the general accelerator circuitry 904, and/or the telemetry function accelerator circuitry 906. In some examples, the telemetry functions are implemented and executed by one or more of the compute units in the device/system/compute node. For example, any one or more of the telemetry function accelerator circuitry 906, the general accelerator circuitry 904, and/or the general processor circuitry 902 may include telemetry function executor circuitry. In some examples, the telemetry function executor circuitry 1110, when implemented in the general accelerator circuitry 904 and/or the telemetry function accelerator circuitry 906, provides hardware accelerated telemetry function execution. In some examples, the telemetry function executor circuitry 1110, when implemented in the telemetry function accelerator circuitry 906, provides dedicated hardware accelerated telemetry function execution). In some examples, the hardware accelerated telemetry function executors 904 and/or 906 includes a number (N) of units of simple accelerated functions. The example general processor circuitry 902 also can capably provide telemetry function management and computations, but in a software-implemented manner.

In FIG. 11B, the example telemetry function executor circuitry 1110 includes monitoring function parser circuitry 1112 to parse the information stored in the monitoring function registry interface data structure 910 and in the application assignment interface data structure 912. For example, the telemetry function executor circuitry 1110 can parse a monitoring function stored in the monitoring function registry interface data structure 910 into a set of operations. The set of operations may include the function definition 1004 to be executed, the set of metrics 1002, and the function ID 1000.

In some examples, the apparatus includes means for parsing the first monitoring function into a set of operations. For example, the means for parsing may be implemented by the monitoring function parser circuitry 1112. In some examples, the monitoring function parser circuitry 1112 may be implemented by machine executable instructions such as that implemented by at least block 1112 of FIG. 11 executed by processor circuitry, which may be implemented by the example processor circuitry 1712 of FIG. 17, the example processor circuitry 1800 of FIG. 18, and/or the example Field Programmable Gate Array (FPGA) circuitry 1900 of FIG. 19. In other examples, the monitoring function parser circuitry 1112 is implemented by other hardware logic circuitry, hardware implemented state machines, and/or any other combination of hardware, software, and/or firmware. For example, the monitoring function parser circuitry 1112 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In FIG. 11B, the example telemetry function executor circuitry 1110 includes hardware and software monitoring logic stack configuration circuitry 1114. In some examples, once the monitoring function is parsed, then the example telemetry function executors (e.g., telemetry function accelerator circuitry 906, the general accelerator circuitry 904, and/or the general processor circuitry 902) configure the hardware and software monitoring logic stack (e.g., hardware/accelerator logic and the software application(s) and operating system) to perform the monitoring (e.g., telemetry metrics collection and monitoring operations/instructions). The configuration may include, in some examples, launching complementary software functions that interlace with the hardware and software monitoring logic stack to create a fully operational environment to successfully monitor and compute telemetry data in regard to the application instance being monitored.

In some examples, the apparatus includes means for configuring the hardware and software monitoring logic stack to perform the monitoring. For example, the means for configuring may be implemented by the hardware and software monitoring logic stack configuration circuitry 1114. In some examples, the hardware and software monitoring logic stack configuration circuitry 1114 may be implemented by machine executable instructions such as that implemented by at least block 1114 of FIG. 11 executed by processor circuitry, which may be implemented by the example processor circuitry 1712 of FIG. 17, the example processor circuitry 1800 of FIG. 18, and/or the example Field Programmable Gate Array (FPGA) circuitry 1900 of FIG. 19. In other examples, the hardware and software monitoring logic stack configuration circuitry 1114 is implemented by other hardware logic circuitry, hardware implemented state machines, and/or any other combination of hardware, software, and/or firmware. For example, the hardware and software monitoring logic stack configuration circuitry 1114 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In FIG. 11B, the example telemetry function executor circuitry 1110 includes monitoring function execution circuitry 1114. In some examples, the telemetry function executor circuitry 1110 (e.g., the monitoring function execution circuitry 1114 present in the telemetry function accelerator circuitry 906, the general accelerator circuitry 904, and/or the general processor circuitry 902) then directly executes the set of operations that were parsed. The set of operations may include a series of function calls, an executable bit-stream, one or more series of function calls to secondary logic to help with the monitoring, or some combination of the above options. In some examples, the telemetry function executors (e.g., telemetry function accelerator circuitry 906, the general accelerator circuitry 904, and/or the general processor circuitry 902) further initiate hardware and/or software components that perform the needed monitoring. Thus, initialization and function calls to other hardware/software on the compute node circuitry 924 and/or initialization and function calls to hardware/software on other compute nodes may be implemented. In some examples, a large number of monitoring-accelerated telemetry harnessing units, such as telemetry function executors (e.g., telemetry function accelerator circuitry 906, the general accelerator circuitry 904, and/or the general processor circuitry 902), are available. In some examples, the large number of available compute units to serve these functions allows for fine-grained and scalable execution of just-in-time and just-as-needed telemetry data gathering/processing.

In some examples, the apparatus includes means for directly executing the set of operations (e.g., the operations that were parsed). For example, the means for executing may be implemented by monitoring function execution circuitry 1114. In some examples, the monitoring function execution circuitry 1114 may be implemented by machine executable instructions such as that implemented by at least block 1114 of FIG. 11 executed by processor circuitry, which may be implemented by the example processor circuitry 1712 of FIG. 17, the example processor circuitry 1800 of FIG. 18, and/or the example Field Programmable Gate Array (FPGA) circuitry 1900 of FIG. 19. In other examples, the monitoring function execution circuitry 1114 is implemented by other hardware logic circuitry, hardware implemented state machines, and/or any other combination of hardware, software, and/or firmware. For example, the monitoring function execution circuitry 1114 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the apparatus includes means for initiating additional hardware and/or software components to perform the needed monitoring. For example, the means for initiating may be implemented by the telemetry function executor circuitry 1110. In some examples, the telemetry function executor circuitry 1110 may be implemented by machine executable instructions such as that implemented by at least block 1110 of FIG. 11 executed by processor circuitry, which may be implemented by the example processor circuitry 1712 of FIG. 17, the example processor circuitry 1800 of FIG. 18, and/or the example Field Programmable Gate Array (FPGA) circuitry 1900 of FIG. 19. In other examples, the telemetry function executor circuitry 1110 is implemented by other hardware logic circuitry, hardware implemented state machines, and/or any other combination of hardware, software, and/or firmware. For example, the telemetry function executor circuitry 1110 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

While an example manner of implementing the telemetry monitoring circuitry 926 is illustrated in FIG. 9, one or more of the elements, processes, and/or devices illustrated in FIG. 9 may be combined, divided, re-arranged, omitted, eliminated, and/or implemented in any other way. Further, the example general platform compute circuitry 900, the example general processor circuitry 902, the example general accelerator circuitry 904, the example telemetry function accelerator circuitry 906 (including the following detailed circuitries implemented in the example telemetry function executor circuitry 1110, which itself is implemented in one or more of 902, 904, and/or 906: the monitoring function parser circuitry 1112, the hardware and software monitoring logic stack configuration circuitry 1114, and the monitoring function execution circuitry 1116), the example memory circuitry 908, the example monitoring function registry interface data structure 910, the example application assignment interface data structure 912, the example SLA monitoring circuitry 914 (including the following circuitries implemented within the SLA monitoring circuitry 914 in FIG. 11A: example monitoring function instantiator circuitry 1100, the application instance criticality determiner circuitry 1102, the resource utilization monitoring circuitry 1104, the monitoring function execution starter circuitry 1106, and the QoS callback generator circuitry 1108), the example QoS enforcing circuitry 916, the example dedicated telemetry compute circuitry 918, the example management controller circuitry 920, the example interface management circuitry 922, and/or, more generally, the example telemetry monitoring circuitry 926 of FIG. 9, may be implemented by hardware, software, firmware, and/or any combination of hardware, software, and/or firmware. Thus, for example, any of the example general platform compute circuitry 900, the example general processor circuitry 902, the example general accelerator circuitry 904, the example telemetry function accelerator circuitry 906 (including the following detailed circuitries implemented in the example telemetry function executor circuitry 1110, which itself is implemented in one or more of 902, 904, and/or 906: the monitoring function parser circuitry 1112, the hardware and software monitoring logic stack configuration circuitry 1114, and the monitoring function execution circuitry 1116), the example memory circuitry 908, the example monitoring function registry interface data structure 910, the example application assignment interface data structure 912, the example SLA monitoring circuitry 914 (including the following circuitries implemented within the SLA monitoring circuitry 914 in FIG. 11A: example monitoring function instantiator circuitry 1100, the application instance criticality determiner circuitry 1102, the resource utilization monitoring circuitry 1104, the monitoring function execution starter circuitry 1106, and the QoS callback generator circuitry 1108), the example QoS enforcing circuitry 916, the example dedicated telemetry compute circuitry 918, the example management controller circuitry 920, the example interface management circuitry 922, and/or, more generally, the example telemetry monitoring circuitry 926, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example general platform compute circuitry 900, the example general processor circuitry 902, the example general accelerator circuitry 904, the example telemetry function accelerator circuitry 906 (including the following detailed circuitries implemented in the example telemetry function executor circuitry 1110, which itself is implemented in one or more of 902, 904, and/or 906: the monitoring function parser circuitry 1112, the hardware and software monitoring logic stack configuration circuitry 1114, and the monitoring function execution circuitry 1116), the example memory circuitry 908, the example monitoring function registry interface data structure 910, the example application assignment interface data structure 912, the example SLA monitoring circuitry 914 (including the following circuitries implemented within the SLA monitoring circuitry 914 in FIG. 11A: example monitoring function instantiator circuitry 1100, the application instance criticality determiner circuitry 1102, the resource utilization monitoring circuitry 1104, the monitoring function execution starter circuitry 1106, and the QoS callback generator circuitry 1108), the example QoS enforcing circuitry 916, the example dedicated telemetry compute circuitry 918, the example management controller circuitry 920, the example interface management circuitry 922, and/or, more generally, the example telemetry monitoring circuitry 926, is/are hereby expressly defined to include a non-transitory computer-readable storage device or storage disk such as a memory, a digital versatile disk (DVD), a compact disk (CD), a Blu-ray disk, etc., including the software and/or firmware. Further still, the example telemetry monitoring circuitry 926 of FIG. 9 may include one or more elements, processes, and/or devices in addition to, or instead of, those illustrated in FIG. 9, and/or may include more than one of any or all of the illustrated elements, processes and devices.

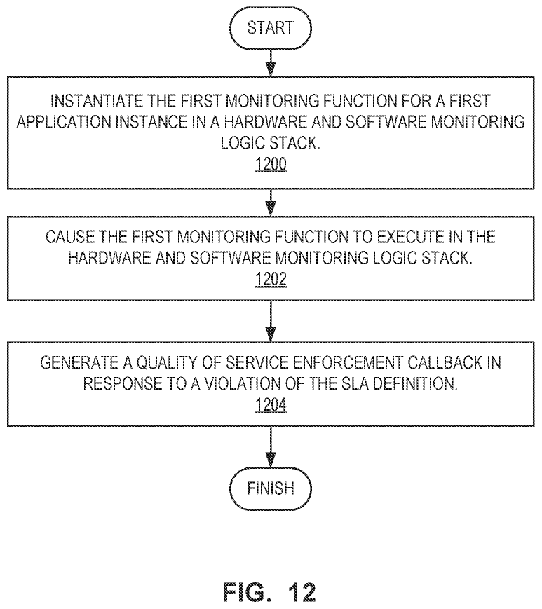

A flowchart representative of example hardware logic circuitry, machine readable instructions, hardware implemented state machines, and/or any combination thereof for implementing the SLA monitoring circuitry of FIG. 914 is shown in FIG. 12. The machine readable instructions may be one or more executable programs or portion(s) of an executable program for execution by processor circuitry, such as the processor circuitry 1712 shown in the example processor platform 1700 discussed below in connection with FIG. 17 and/or the example processor circuitry discussed below in connection with FIGS. 18 and/or 19. The program may be embodied in software stored on one or more non-transitory computer-readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer-readable storage media may include one or more mediums located in one or more hardware devices. Further, although the example program is described with reference to the flowchart illustrated in FIG. 12, many other methods of implementing the example SLA monitoring circuitry 914 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 12-16 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer-readable medium and non-transitory computer-readable storage medium is expressly defined to include any type of computer-readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 12 is a flowchart representative of example machine readable instructions and/or example operations that may be executed and/or instantiated by processor circuitry to instantiate and cause a telemetry monitoring function to run and report SLA violations in a compute node.

The machine readable instructions and/or operations of FIG. 12 are described in connection with the example SLA monitoring circuitry 914, the example monitoring function instantiator circuitry 1100, the example monitoring function execution starter circuitry 1106, and the example QoS callback generator circuitry 1108 of FIGS. 9 and 11A.

In the illustrated example of FIG. 12, when a telemetry monitoring function is to be implemented in a compute node, the process begins. At block 1200, the example monitoring function instantiator circuitry 1100 instantiates the first monitoring function for a first application instance in a hardware and software monitoring logic stack. In some examples, the hardware and software monitoring logic stack includes the entire stack from software applications and the operating system on down to the low level hardware utilized to perform the telemetry data collection and computation. In some examples, the hardware and software monitoring logic stack may utilize an instantiated monitoring function in general processor circuitry 902 through a software implemented stack, in a general accelerator circuitry 904 through a hardware acceleration implemented stack, or in a telemetry function accelerator circuitry 906 that is a dedicated resource (with N number of dedicated accelerator circuitries) to utilize for monitoring function compute requirements.

At block 1202, the example monitoring function execution starter circuitry 1106 causes the first monitoring function to execute in the hardware and software monitoring logic stack 1202. In some examples, the monitoring function execution starter circuitry 1106 executes a call/operation to the hardware and software monitoring logic stack to begin monitoring function execution for the linked/designated application instance being monitored.

At block 1204, the example QoS callback generator circuitry 1108 generates a quality of service enforcement callback in response to a violation of the SLA definition. In some examples, the service enforcement callback is not generated in response to no violation of a SLA requirements. In some examples, when a violation to the SLA definition has taken place, the QoS callback generated circuitry 1108 generates a callback after the violation occurs (through the notification process from the SLA monitoring circuitry 914 to the QoS enforcing circuitry 916). In other examples, the SLA monitoring circuitry 914 keeps track of data that is utilized in SLA definitions and a “pre-callback” is generated in response to a trendline showing an SLA violation is imminent or at a minimum the data is trending towards a violation. In some examples, the QoS enforcing circuitry may implement prescriptive measures with the general platform compute circuitry 900 in advance of a violation to attempt to prevent the violation from occurring.

At this point the process ends.

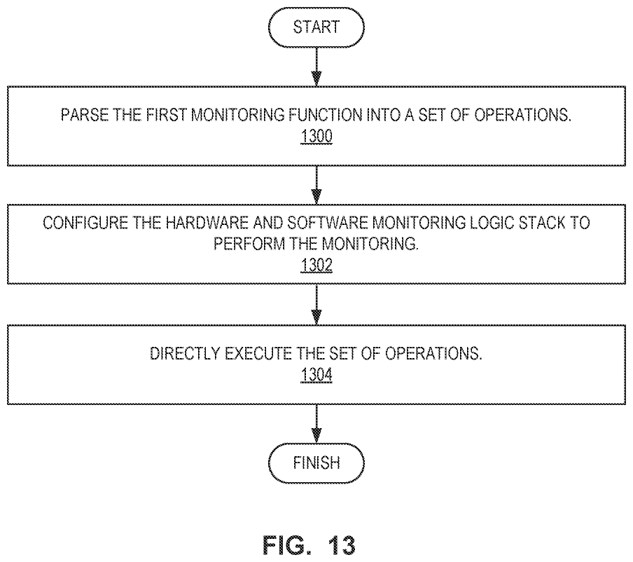

FIG. 13 is a flowchart representative of example machine readable instructions and/or example operations that may be executed and/or instantiated by processor circuitry to parse a telemetry monitoring function, configure a logic stack to run the telemetry monitoring function, and directly execute the parsed operations in a compute node.

The machine readable instructions and/or operations of FIG. 13 are described in connection with the example telemetry function executor circuitry 1110, the example monitoring function parser circuitry 1112, the example hardware and software monitoring logic stack configuration circuitry 1114, and the example monitoring function execution circuitry 1116, of FIGS. 9 and 11B.

In the illustrated example of FIG. 13, when a telemetry monitoring function is to be parsed by an executor in a compute node, the process begins. At block 1300, the example monitoring function parser circuitry 1112 parses the first monitoring function into a set of operations. In some examples, the monitoring function parser circuitry 1112 utilizes a predetermined format of the monitoring function. In some examples, the monitoring function is a standard function that follows a template. In some examples, the monitoring function is new/unique and a pointer to detailed structural aspects of the monitoring function operations are stored in an accessible location. In some examples, packages of monitoring functions are distributed with the SLA requirements, wherein the agreement not only specifies the requirements, but how the data is to be monitored to verify the requirements are met.

At block 1302, the example hardware and software monitoring logic stack configuration circuitry 1114 configures the hardware and software monitoring logic stack to perform the monitoring. In some examples, the hardware and software monitoring logic stack configuration circuitry 1114 has a series of configuration steps through a process that is known to secure resources needed to implement the monitoring process. In some examples, the resources are all local and there are a series of step functions that correspond to the criticality of the monitoring function vs the type of hardware and software utilized to support such a monitoring function (e.g., the more important the monitoring function, the higher priority the monitoring function gets with such resources vs. other tasks competing for the same resources, the more of such resource the monitoring function is designated, etc.).

At block 1304, the example monitoring function execution circuitry 1116 directly executes the set of operations. As previously stated, the example monitoring function execution circuitry 1116 may include general processor circuitry 902, general accelerator circuitry 904, and or telemetry function accelerator circuitry 906, the decision between such types of circuitry may be a function of the criticality of the monitoring function. Additionally, depending on the type of circuitry utilized to execute the monitoring function, the set of operations utilized to execute the monitoring function may vary. For example, if the monitoring function is high criticality, a direct bit-stream of the high priority function may be streamed into the telemetry function accelerator circuitry 906 for processing by the dedicated telemetry compute circuitry 918. The direct bit-stream may be referred to as an accelerated function. Additionally, the telemetry function accelerator circuitry 906 may send out calls to remote resources for further help with monitoring function compute needs.

At this point the process ends.

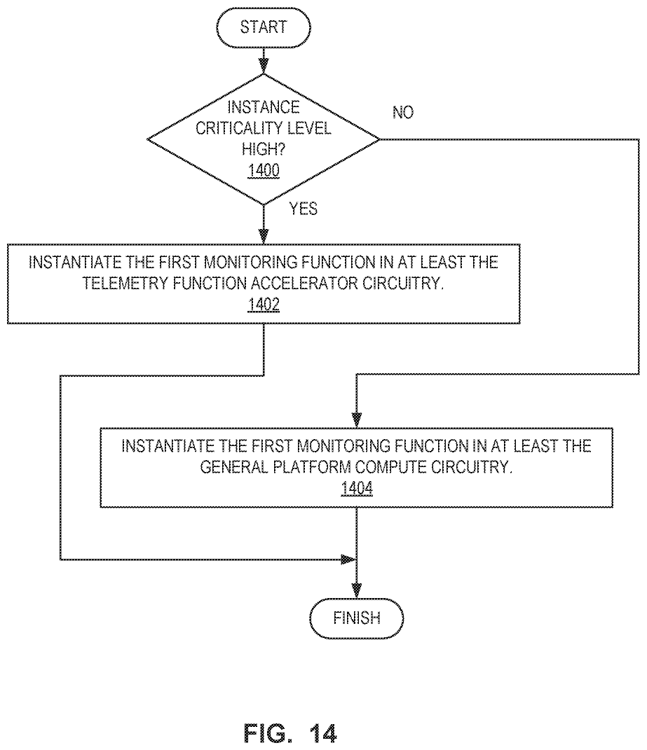

FIG. 14 is a flowchart representative of example machine readable instructions and/or example operations that may be executed and/or instantiated by processor circuitry to instantiate a monitoring function in one of several compute circuitries based on an application instance criticality level.

The machine readable instructions and/or operations of FIG. 14 are described in connection with the example SLA monitoring circuitry 914, the example monitoring function instantiator circuitry 1100, and the example application instance criticality determiner circuitry 1102, of FIGS. 9 and 11A.

In the illustrated example of FIG. 14, when a telemetry monitoring function is to be instantiated on one of several compute circuitries based on the criticality level of the application instance to be monitored, the process begins. At block 1400, the example application instance criticality determiner circuitry 1102 determines whether the application instance criticality level is high.

If the application instance criticality level is high, then at block 1402, the example monitoring function instantiator circuitry 1100 (or more generally the SLA monitoring circuitry 914) instantiates the first monitoring function in at least the telemetry function accelerator circuitry (906 of FIG. 9) (i.e., in response to the instance criticality level being high).

If the application instance criticality level is not high, then at block 1404, the example monitoring function instantiator circuitry 1100 (or more generally the SLA monitoring circuitry 914) instantiates the first monitoring function in at least the general platform compute circuitry (900 of FIG. 9) (i.e., in response to the instance criticality level being less than high). In different examples, “less than high” may correspond to a low criticality level, a medium criticality level, or any criticality level other than a high criticality level.

At this point the process ends.

FIG. 14 shows one simple example of a two-state criticality decision-making process (e.g., high vs. not-high criticality level). In many other examples, there are more than two criticality states (e.g., 3, 5, 10, or more). The more criticality states there are, the finer-grained the SLA monitoring circuitry 914 can be with managing a wide array of monitoring function requests. The fine-grained approach allows for a more customized SLA requirements document when engaging with users/customers that have unique needs. It should be appreciated that the flowchart in FIG. 14 could be expanded to accommodate many criticality levels and the instantiation blocks (e.g., 1402 and 1404) can instantiate monitoring functions on highly customized versions of hardware and software monitoring logic stacks.

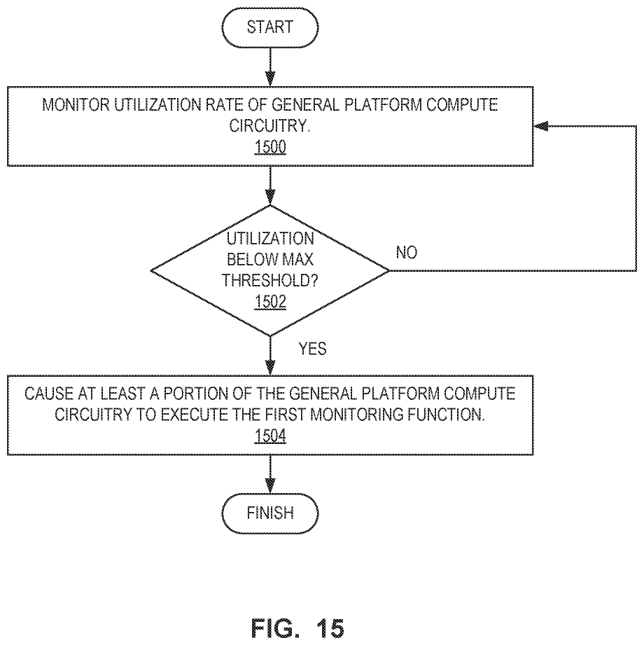

FIG. 15 is a flowchart representative of example machine readable instructions and/or example operations that may be executed and/or instantiated by processor circuitry to monitor the utilization rate of a platform resource and execute a monitoring function on a specific platform resource as a result of the utilization rate being below a threshold value.

The machine readable instructions and/or operations of FIG. 15 are described in connection with the example SLA monitoring circuitry 914, the example resource utilization monitoring circuitry 1104, and the example monitoring function execution starter circuitry 1106, of FIGS. 9 and 11A.

In the illustrated example of FIG. 15, when a platform resource utilization rate is to be monitored to determine what platform resource should execute a monitoring function, the process begins. At block 1500, the example resource utilization monitoring circuitry 1104 monitors a utilization rate of a general platform compute circuitry (900 of FIG. 9).

At block 1502, the example resource utilization monitoring circuitry 1104, then determines whether the monitored utilization rate is below a maximum threshold value.

If the utilization rate is below the maximum threshold value, then, at block 1504, the example monitoring function execution starter circuitry 1106 causes at least a portion of the general platform compute circuitry to execute the first monitoring function.

If the utilization rate is at or above the maximum threshold value, then the example resource utilization monitoring circuitry 1104 returns to block 1500 to further monitor the utilization rate of the general platform compute circuitry.

At this point the process ends.

In other examples, the opposite version of a utilization rate may be utilized. For example, the utilization rate may fall below a minimum threshold value and the example resource utilization monitoring circuitry 1104 may then have the ability (through the SLA definition) to move a higher criticality monitoring function to less efficient compute capabilities. In the example shown in FIG. 9, the telemetry monitoring circuitry 926 has three distinct levels of potentially available hardware compute resources (e.g., the general processor circuitry 902 and the general accelerator circuitry 904 within the general platform compute circuitry 900 and the telemetry function accelerator circuitry 906 that has available to it the dedicated telemetry compute circuitry 918). In other examples, more (or less) distinct levels of available hardware compute resources may be available to further distinguish hardware and software monitoring function logic stack options.

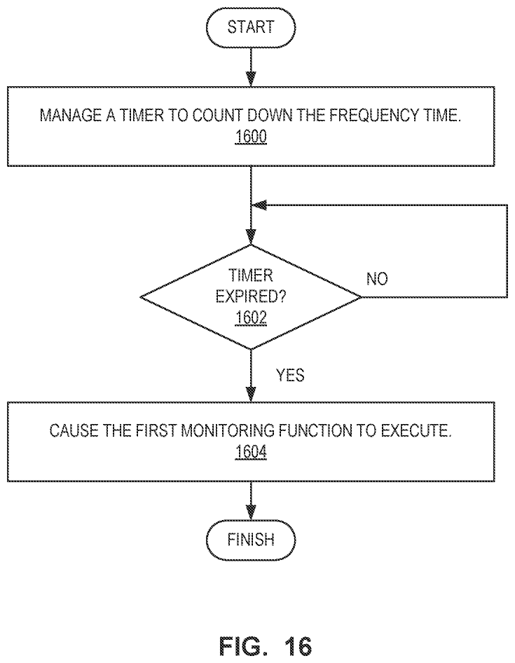

FIG. 16 is a flowchart representative of example machine readable instructions and/or example operations that may be executed and/or instantiated by processor circuitry to manage the frequency of the execution of a monitoring function.

The machine readable instructions and/or operations of FIG. 16 are described in connection with the example SLA monitoring circuitry 914 and the example monitoring function execution starter circuitry 1106 of FIGS. 9 and 11A.

In the illustrated example of FIG. 15, when a monitoring function is to be executed after a certain amount of time, the process begins. At block 1600, the example monitoring function execution starter circuitry 1106 manages a timer to count down the frequency time (e.g., a frequency time value that is a number of microseconds, milliseconds, seconds, etc. between each execution of a given monitoring function). In some examples, the frequency time indicates a monitoring function frequency (i.e., the frequency the monitoring function is executed).

At block 1602, the example monitoring function execution starter circuitry 1106 then checks if the timer has expired.

If the timer has expired, then at block 1604, the example monitoring function execution starter circuitry 1106 causes the first monitoring function to execute.

If the timer has not expired, then the example monitoring function execution starter circuitry 1106 returns to block 1602 to check if the timer has expired again.

At this point the process ends.

The processor platform 1700 of the illustrated example includes processor circuitry 1712. The processor circuitry 1712 of the illustrated example is hardware. For example, the processor circuitry 1712 can be implemented by one or more integrated circuits, logic circuits, FPGAs microprocessors, CPUs, GPUs, DSPs, and/or microcontrollers from any desired family or manufacturer. The processor circuitry 1712 may be implemented by one or more semiconductor based (e.g., silicon based) devices. In this example, the processor circuitry 1712 implements the example general platform compute circuitry 900, the example general processor circuitry 902, the example general accelerator circuitry 904, the example telemetry function accelerator circuitry 906 (including the following detailed circuitries implemented in the example telemetry function executor circuitry 1110, which itself is implemented in one or more of 902, 904, and/or 906: the monitoring function parser circuitry 1112, the hardware and software monitoring logic stack configuration circuitry 1114, and the monitoring function execution circuitry 1116), the example memory circuitry 908, the example monitoring function registry interface data structure 910, the example application assignment interface data structure 912, the example SLA monitoring circuitry 914 (including the following circuitries implemented within the SLA monitoring circuitry 914 in FIG. 11A: example monitoring function instantiator circuitry 1100, the application instance criticality determiner circuitry 1102, the resource utilization monitoring circuitry 1104, the monitoring function execution starter circuitry 1106, and the QoS callback generator circuitry 1108), the example QoS enforcing circuitry 916, the example dedicated telemetry compute circuitry 918, the example management controller circuitry 920, the example interface management circuitry 922, and/or, more generally, the example telemetry monitoring circuitry 926 of FIG. 9.

The processor circuitry 1712 of the illustrated example includes a local memory 1713 (e.g., a cache, registers, etc.). The processor circuitry 1712 of the illustrated example is in communication with a main memory including a volatile memory 1714 and a non-volatile memory 1716 by a bus 1718. The volatile memory 1714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1716 may be implemented by flash memory and/or any other desired type of memory device. Access to the main memory 1714, 1716 of the illustrated example is controlled by a memory controller 1717.

The processor platform 1700 of the illustrated example also includes interface circuitry 1720. The interface circuitry 1720 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1722 are connected to the interface circuitry 1720. The input device(s) 1722 permit(s) a user to enter data and/or commands into the processor circuitry 1712. The input device(s) 1722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1724 are also connected to the interface circuitry 1720 of the illustrated example. The output devices 1724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1720 of the illustrated example, thus, typically includes a graphics driver card, a graphics driver chip, and/or graphics processor circuitry such as a GPU.

The interface circuitry 1720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1700 of the illustrated example also includes one or more mass storage devices 1728 to store software and/or data. Examples of such mass storage devices 1728 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1732, which may be implemented by the machine readable instructions of FIGS. 12-16, may be stored in the mass storage device 1728, in the volatile memory 1714, in the non-volatile memory 1716, and/or on a removable non-transitory computer-readable storage medium such as a CD or DVD.

FIG. 5 is a block diagram of an example implementation of the processor circuitry 1712 of FIG. 17. In this example, the processor circuitry 1712 of FIG. 17 is implemented by a microprocessor 1800. For example, the microprocessor 1800 may implement multi-core hardware circuitry such as a CPU, a DSP, a GPU, an XPU, etc. Although it may include any number of example cores 1802 (e.g., 1 core), the microprocessor 1800 of this example is a multi-core semiconductor device including N cores. The cores 1802 of the microprocessor 1800 may operate independently or may cooperate to execute machine readable instructions. For example, machine code corresponding to a firmware program, an embedded software program, or a software program may be executed by one of the cores 1802 or may be executed by multiple ones of the cores 1802 at the same or different times. In some examples, the machine code corresponding to the firmware program, the embedded software program, or the software program is split into threads and executed in parallel by two or more of the cores 1802. The software program may correspond to a portion or all of the machine readable instructions and/or operations represented by the flowcharts of FIGS. 12-16.

The cores 1802 may communicate by an example bus 1804. In some examples, the bus 1804 may implement a communication bus to effectuate communication associated with one(s) of the cores 1802. For example, the bus 1804 may implement at least one of an Inter-Integrated Circuit (I2C) bus, a Serial Peripheral Interface (SPI) bus, a PCI bus, or a PCIe bus. Additionally or alternatively, the bus 1804 may implement any other type of computing or electrical bus. The cores 1802 may obtain data, instructions, and/or signals from one or more external devices by example interface circuitry 1806. The cores 1802 may output data, instructions, and/or signals to the one or more external devices by the interface circuitry 1806. Although the cores 1802 of this example include example local memory 1820 (e.g., Level 1 (L1) cache that may be split into an L1 data cache and an L1 instruction cache), the microprocessor 1800 also includes example shared memory 1810 that may be shared by the cores (e.g., Level 2 (L2_cache)) for high-speed access to data and/or instructions. Data and/or instructions may be transferred (e.g., shared) by writing to and/or reading from the shared memory 1810. The local memory 1820 of each of the cores 1802 and the shared memory 1810 may be part of a hierarchy of storage devices including multiple levels of cache memory and the main memory (e.g., the main memory 1714, 1716 of FIG. 17). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1802 may be referred to as a CPU, DSP, GPU, etc., or any other type of hardware circuitry. Each core 1802 includes control unit circuitry 1814, arithmetic and logic (AL) circuitry (sometimes referred to as an ALU) 1816, a plurality of registers 1818, the L1 cache 1820, and an example bus 1822. Other structures may be present. For example, each core 1802 may include vector unit circuitry, single instruction multiple data (SIMD) unit circuitry, load/store unit (LSU) circuitry, branch/jump unit circuitry, floating-point unit (FPU) circuitry, etc. The control unit circuitry 1814 includes semiconductor-based circuits structured to control (e.g., coordinate) data movement within the corresponding core 1802. The AL circuitry 1816 includes semiconductor-based circuits structured to perform one or more mathematic and/or logic operations on the data within the corresponding core 1802. The AL circuitry 1816 of some examples performs integer based operations. In other examples, the AL circuitry 1816 also performs floating point operations. In yet other examples, the AL circuitry 1816 may include first AL circuitry that performs integer based operations and second AL circuitry that performs floating point operations. In some examples, the AL circuitry 1816 may be referred to as an Arithmetic Logic Unit (ALU). The registers 1818 are semiconductor-based structures to store data and/or instructions such as results of one or more of the operations performed by the AL circuitry 1816 of the corresponding core 1802. For example, the registers 1818 may include vector register(s), SIMD register(s), general purpose register(s), flag register(s), segment register(s), machine specific register(s), instruction pointer register(s), control register(s), debug register(s), memory management register(s), machine check register(s), etc. The registers 1818 may be arranged in a bank as shown in FIG. 18. Alternatively, the registers 1818 may be organized in any other arrangement, format, or structure including distributed throughout the core 1802 to shorten access time. The bus 1820 may implement at least one of an I2C bus, a SPI bus, a PCI bus, or a PCIe bus

Each core 1802 and/or, more generally, the microprocessor 1800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1800 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 19 is a block diagram of another example implementation of the processor circuitry 1712 of FIG. 17. In this example, the processor circuitry 1712 is implemented by FPGA circuitry 1900. The FPGA circuitry 1900 can be used, for example, to perform operations that could otherwise be performed by the example microprocessor 1800 of FIG. 18 executing corresponding machine readable instructions. However, once configured, the FPGA circuitry 1900 instantiates the machine readable instructions in hardware and, thus, can often execute the operations faster than they could be performed by a general purpose microprocessor executing the corresponding software.

More specifically, in contrast to the microprocessor 1800 of FIG. 18 described above (which is a general purpose device that may be programmed to execute some or all of the machine readable instructions represented by the flowcharts of FIG. 12-16 but whose interconnections and logic circuitry are fixed once fabricated), the FPGA circuitry 1900 of the example of FIG. 19 includes interconnections and logic circuitry that may be configured and/or interconnected in different ways after fabrication to instantiate, for example, some or all of the machine readable instructions represented by the flowcharts of FIG. 12-16. In particular, the FPGA 1900 may be thought of as an array of logic gates, interconnections, and switches. The switches can be programmed to change how the logic gates are interconnected by the interconnections, effectively forming one or more dedicated logic circuits (unless and until the FPGA circuitry 1900 is reprogrammed). The configured logic circuits enable the logic gates to cooperate in different ways to perform different operations on data received by input circuitry. Those operations may correspond to some or all of the software represented by the flowcharts of FIG. 12-16. As such, the FPGA circuitry 1900 may be structured to effectively instantiate some or all of the machine readable instructions of the flowcharts of FIG. 12-16 as dedicated logic circuits to perform the operations corresponding to those software instructions in a dedicated manner analogous to an ASIC. Therefore, the FPGA circuitry 1900 may perform the operations corresponding to the some or all of the machine readable instructions of FIGS. 12-16 faster than the general purpose microprocessor can execute the same.

In the example of FIG. 19, the FPGA circuitry 1900 is structured to be programmed (and/or reprogrammed one or more times) by an end user by a hardware description language (HDL) such as Verilog. The FPGA circuitry 1900 of FIG. 19, includes example input/output (I/O) circuitry 1902 to obtain and/or output data to/from example configuration circuitry 1904 and/or external hardware (e.g., external hardware circuitry) 1906. For example, the configuration circuitry 1904 may implement interface circuitry that may obtain machine readable instructions to configure the FPGA circuitry 1900, or portion(s) thereof. In some such examples, the configuration circuitry 1904 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1906 may implement the microprocessor 1800 of FIG. 18. The FPGA circuitry 1900 also includes an array of example logic gate circuitry 1908, a plurality of example configurable interconnections 1910, and example storage circuitry 1912. The logic gate circuitry 1908 and interconnections 1910 are configurable to instantiate one or more operations that may correspond to at least some of the machine readable instructions of FIGS. 12-16 and/or other desired operations. The logic gate circuitry 1908 shown in FIG. 19 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1908 to enable configuration of the electrical structures and/or the logic gates to form circuits to perform desired operations. The logic gate circuitry 1908 may include other electrical structures such as look-up tables (LUTs), registers (e.g., flip-flops or latches), multiplexers, etc.

The interconnections 1910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1908 to program desired logic circuits.

The storage circuitry 1912 of the illustrated example is structured to store result(s) of the one or more of the operations performed by corresponding logic gates. The storage circuitry 1912 may be implemented by registers or the like. In the illustrated example, the storage circuitry 1912 is distributed amongst the logic gate circuitry 1908 to facilitate access and increase execution speed.

The example FPGA circuitry 1900 of FIG. 19 also includes example Dedicated Operations Circuitry 1914. In this example, the Dedicated Operations Circuitry 1914 includes special purpose circuitry 1916 that may be invoked to implement commonly used functions to avoid the need to program those functions in the field. Examples of such special purpose circuitry 1916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1900 may also include example general purpose programmable circuitry 1918 such as an example CPU 1920 and/or an example DSP 1922. Other general purpose programmable circuitry 1918 may additionally or alternatively be present such as a GPU, an XPU, etc., that can be programmed to perform other operations.

Although FIGS. 5 and 6 illustrate two example implementations of the processor circuitry 412 of FIG. 4, many other approaches are contemplated. For example, as mentioned above, modern FPGA circuitry may include an on-board CPU, such as one or more of the example CPU 1920 of FIG. 19. Therefore, the processor circuitry 1712 of FIG. 17 may additionally be implemented by combining the example microprocessor 1800 of FIG. 18 and the example FPGA circuitry 1900 of FIG. 19. In some such hybrid examples, a first portion of the machine readable instructions represented by the flowcharts of FIG. 12-16 may be executed by one or more of the cores 1802 of FIG. 18 and a second portion of the machine readable instructions represented by the flowcharts of FIG. 12-16 may be executed by the FPGA circuitry 1900 of FIG. 19.

In some examples, the processor circuitry 1712 of FIG. 17 may be in one or more packages. For example, the processor circuitry 1800 of FIG. 18 and/or the FPGA circuitry 1900 of FIG. 19 may be in one or more packages. In some examples, an XPU may be implemented by the processor circuitry 1712 of FIG. 17, which may be in one or more packages. For example, the XPU may include a CPU in one package, a DSP in another package, a GPU in yet another package, and an FPGA in still yet another package.

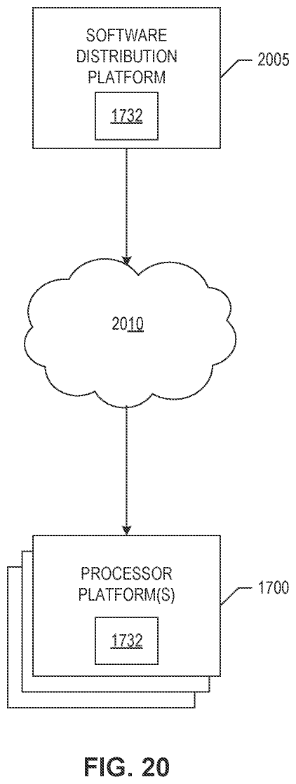

A block diagram illustrating an example software distribution platform 2005 to distribute software such as the example machine readable instructions 1732 of FIG. 17 to hardware devices owned and/or operated by third parties is illustrated in FIG. 20. The example software distribution platform 2005 may be implemented by any computer server, data facility, cloud service, etc., capable of storing and transmitting software to other computing devices. The third parties may be customers of the entity owning and/or operating the software distribution platform 2005. For example, the entity that owns and/or operates the software distribution platform 2005 may be a developer, a seller, and/or a licensor of software such as the example machine readable instructions 1732 of FIG. 17. The third parties may be consumers, users, retailers, OEMs, etc., who purchase and/or license the software for use and/or re-sale and/or sub-licensing. In the illustrated example, the software distribution platform 2005 includes one or more servers and one or more storage devices. The storage devices store the machine readable instructions 1732, which may correspond to the example machine readable instructions 1200, 1300, 1400, 1500, and 1600 of FIGS. 12-16, as described above. The one or more servers of the example software distribution platform 2005 are in communication with a network 2010, which may correspond to any one or more of the Internet and/or any of the example networks 2010 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1732 from the software distribution platform 2005. For example, the software, which may correspond to the example machine readable instructions 1200, 1300, 1400, 1500, and 1600 of FIGS. 12-16, may be downloaded to the example processor platform 1700, which is to execute the machine readable instructions 1732 to implement the telemetry monitoring circuitry 926. In some examples, one or more servers of the software distribution platform 2005 periodically offer, transmit, and/or force updates to the software (e.g., the example machine readable instructions 1732 of FIG. 17) to ensure improvements, patches, updates, etc., are distributed and applied to the software at the end user devices.

From the foregoing, it will be appreciated that example systems, methods, apparatus, and articles of manufacture have been disclosed that implement edge scalable adaptive-grained monitoring and telemetry processing for multi-QoS services. The disclosed systems, methods, apparatus, and articles of manufacture improve the efficiency of using a computing device by implementing a customized and fine-grained approach to monitoring telemetry data and providing compute resources commensurate with the monitoring functions at hand. The disclosed systems, methods, apparatus, and articles of manufacture are accordingly directed to one or more improvement(s) in the operation of a machine such as a computer or other electronic and/or mechanical device.

Example 1 includes an apparatus, comprising platform compute circuitry including at least one of a processor circuitry or an accelerator circuitry, a monitoring function registry interface data structure to include a set of one or more monitoring functions, the monitoring function registry interface data structure providing, for each monitoring function in the set, a unique universal function identifier and a function descriptor, and an application assignment interface data structure to include application instances, the application assignment interface data structure providing, for each application instance, an application identifier, an application service level agreement (SLA) definition, and the function descriptor to enable a link to a first monitoring function, and SLA monitoring circuitry, the SLA monitoring circuitry to instantiate the first monitoring function for a first application instance in a hardware and software monitoring logic stack, cause the first monitoring function to execute in the hardware and software monitoring logic stack, and generate a quality of service (QoS) enforcement callback in response to a violation of the SLA definition.

Example 2 includes the apparatus of example 1, further including telemetry function accelerator circuitry to parse the first monitoring function into a set of operations, and configure the hardware and software monitoring logic stack to execute the set of operations.

Example 3 includes the apparatus of example 2, wherein the hardware and software monitoring logic stack includes at least one of the platform compute circuitry or the telemetry function accelerator circuitry.

Example 4 includes the apparatus of example 3, wherein the application assignment interface data structure further includes, for each application instance, an instance criticality level.

Example 5 includes the apparatus of example 4, wherein the SLA monitoring circuitry is to instantiate the first monitoring function in at least the telemetry function accelerator circuitry in response to the instance criticality level being high, and instantiate the first monitoring function in at least the platform compute circuitry in response to the instance criticality level being less than high.

Example 6 includes the apparatus of example 5, wherein the SLA monitoring circuitry is to monitor a utilization rate of the platform compute circuitry, and in response to the utilization rate being below a maximum threshold value, cause at least a portion of the platform compute circuitry to execute the first monitoring function.

Example 7 includes the apparatus of example 1, wherein the application assignment interface data structure further includes, for each application instance, a frequency time value to indicate a monitoring function frequency of execution and wherein the SLA monitoring circuitry further to manage a timer to count down the frequency time value, and cause the first monitoring function to execute after the timer expires.

Example 8 includes the apparatus of example 1, wherein the monitoring function registry interface data structure includes, for each monitoring function, a telemetry metric list of telemetry metrics to be collected.

Example 9 includes the apparatus of example 8, wherein the SLA monitoring circuitry is further to provide a QoS enforcing circuitry at least one of the function identifier of the first monitoring function, a current set of values of the telemetry metrics, and a result of the execution of the monitoring function.

Example 10 includes the apparatus of example 8, wherein the monitoring function includes at least one of an algorithm represented by an accelerated function, one or more operations to collect the telemetry metrics, or one or more sub-functions invoked to collect a set of telemetry metrics.

Example 11 includes the apparatus of example 1, wherein the application assignment interface data structure further includes, for each application instance, a listing of one or more corrective actions to trigger in response to the SLA monitoring circuitry generating the QoS enforcement callback.

Example 12 includes At least one non-transitory computer-readable storage medium comprising instructions that, when executed, cause one or more processors of a machine to at least cause storage of a monitoring function registry interface data structure to list a set of monitoring functions, the monitoring function registry interface data structure providing, for each monitoring function in the set, a unique universal function identifier and a function descriptor, and cause storage of an application assignment interface data structure to list application instances, the application assignment interface data structure providing, for each application instance, an application identifier, an application service level agreement (SLA) definition, and the function descriptor to enable a link to a first monitoring function, and instantiate the first monitoring function for a first application instance in a hardware and software monitoring logic stack, the hardware and software monitoring logic stack including at least one of a platform compute circuitry or a telemetry function accelerator circuitry, cause the first monitoring function to execute in the hardware and software monitoring logic stack, and generate a quality of service (QoS) enforcement callback in response to a violation of the SLA definition.

Example 13 includes the at least one non-transitory computer-readable storage medium of example 12, wherein the instructions, when executed, cause the one or more of the processors of the machine to parse the first monitoring function into a set of operations, and configure the hardware and software monitoring logic stack to execute the set of operations.

Example 14 includes the at least one non-transitory computer-readable storage medium of example 13, wherein the application assignment interface data structure further includes, for each application instance, an instance criticality level.

Example 15 includes the at least one non-transitory computer-readable storage medium of example 14, wherein the instructions, when executed, cause the one or more of the processors of the machine to instantiate the first monitoring function in at least the telemetry function accelerator circuitry in response to the instance criticality level being high, and instantiate the first monitoring function in at least the platform compute circuitry in response to the instance criticality level being less than high.

Example 16 includes the at least one non-transitory computer-readable storage medium of example 15, wherein the instructions, when executed, cause the one or more of the processors of the machine to monitor a utilization rate of the platform compute circuitry, and in response to the utilization rate being below a maximum threshold value, cause at least a portion of the platform compute circuitry to execute the first monitoring function.

Example 17 includes the at least one non-transitory computer-readable storage medium of example 12, wherein the application assignment interface data structure further includes, for each application instance, a frequency time value to indicate a monitoring function frequency of execution, and wherein the instructions, when executed, cause the one or more of the processors of the machine to manage a timer to count down the frequency time value, and cause the first monitoring function to execute after the timer expires.

Example 18 includes the at least one non-transitory computer-readable storage medium of example 12, wherein the monitoring function registry interface data structure includes, for each monitoring function, a telemetry metric list of telemetry metrics to be collected.

Example 19 includes the at least one non-transitory computer-readable storage medium of example 18, wherein the instructions, when executed, cause the one or more of the processors of the machine to provide a QoS enforcing circuitry at least one of the function identifier of the first monitoring function, a current set of values of the telemetry metrics, and a result of the execution of the monitoring function.

Example 20 includes the at least one non-transitory computer-readable storage medium of example 18, wherein the monitoring function includes at least one of an algorithm represented by an accelerated function, one or more operations to collect the telemetry metrics, or one or more sub-functions invoked to collect a set of telemetry metrics.

Example 21 includes the at least one non-transitory computer-readable storage medium of example 12, wherein the application assignment interface data structure further includes, for each application instance, one or more corrective actions to trigger in response to generating the QoS enforcement callback.

Example 22 includes an apparatus, comprising processor circuitry including one or more of at least one of a central processor unit, a graphic processor unit or a digital signal processor, the at least one of the central processor unit, the graphic processor unit or the digital signal processor having control circuitry to control data movement within the processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations, or an Application Specific Integrate Circuitry (ASIC) including logic gate circuitry to perform one or more third operations, the processor circuitry to perform at least one of the one or more first operations, the one or more second operations or the one or more third operations to instantiate a monitoring function registry interface data structure to list a set of monitoring functions, the monitoring function registry interface data structure including, for each monitoring function in the set, a unique universal function identifier and a function descriptor, application assignment interface data structure to list application instances, the application assignment interface data structure including, for each application instance, an application identifier, an application service level agreement (SLA) definition, and the function descriptor to enable a link to a first monitoring function, SLA monitoring circuitry, the SLA monitoring circuitry to instantiate the first monitoring function for a first application instance in a hardware and software monitoring logic stack, cause the first monitoring function to execute in the hardware and software monitoring logic stack, and generate a quality of service (QoS) enforcement callback in response to a violation of the SLA definition.

Example 23 includes the apparatus of example 22, wherein the processor circuitry to perform at least one of the one or more first operations, the one or more second operations or the one or more third operations to instantiate telemetry function accelerator circuitry to parse the first monitoring function into a set of operations, and configure the hardware and software monitoring logic stack to execute the set of operations.

Example 24 includes the apparatus of example 23, wherein the hardware and software monitoring logic stack includes at least one of accelerator circuitry, the processor circuitry, or the telemetry function accelerator circuitry.

Example 25 includes the apparatus of example 24, wherein the application assignment interface data structure further includes, for each application instance, an instance criticality level.

Example 26 includes the apparatus of example 25, wherein the SLA monitoring circuitry is to instantiate the first monitoring function in at least the telemetry function accelerator circuitry in response to the instance criticality level being high, and instantiate the first monitoring function in at least a platform compute circuitry in response to the instance criticality level being less than high.

Example 27 includes the apparatus of example 26, wherein the SLA monitoring circuitry is to monitor a utilization rate of the platform compute circuitry, and in response to the utilization rate being below a maximum threshold value, cause at least a portion of the platform compute circuitry to execute the first monitoring function.

Example 28 includes the apparatus of example 22, wherein the application assignment interface data structure further includes, for each application instance, a frequency value to indicate a monitoring function frequency of execution and the SLA monitoring circuitry is to manage a timer to count down the frequency value, and cause the first monitoring function to execute after the timer expires.

Example 29 includes the apparatus of example 22, wherein the monitoring function registry interface data structure includes, for each monitoring function, a list of telemetry metrics to be collected.

Example 30 includes the apparatus of example 29, wherein the SLA monitoring circuitry is to provide a QoS enforcing circuitry at least one of the function identifier of the first monitoring function, a current set of values of the list of telemetry metrics, and a result of the execution of the monitoring function.

Example 31 includes the apparatus of example 29, wherein the monitoring function includes at least one of an algorithm represented by an accelerated function, one or more operations to collect a current set of values corresponding of the list of telemetry metrics, or one or more sub-functions invoked to collect the current set of values corresponding to the list of telemetry metrics.

Example 32 includes the apparatus of example 22, wherein the application assignment interface data structure further includes, for each application instance, one or more corrective actions to trigger in response to the SLA monitoring circuitry generating the QoS enforcement callback.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

What is claimed is:

1. An apparatus, comprising:
platform compute circuitry including at least one of a processor circuitry or an accelerator circuitry;
a monitoring function registry interface data structure to include a set of one or more monitoring functions, the monitoring function registry interface data structure providing, for each monitoring function in the set, a unique universal function identifier and a function descriptor; and
an application assignment interface data structure to include application instances, the application assignment interface data structure providing, for each application instance, an application identifier, an application service level agreement (SLA) definition, and the function descriptor to enable a link to a first monitoring function; and
SLA monitoring circuitry, the SLA monitoring circuitry to:
instantiate the first monitoring function for a first application instance in a hardware and software monitoring logic stack;
cause the first monitoring function to execute in the hardware and software monitoring logic stack; and
generate a quality of service (QoS) enforcement callback in response to a violation of the SLA definition.

2. The apparatus of claim 1, further including:
telemetry function accelerator circuitry to:
parse the first monitoring function into a set of operations; and
configure the hardware and software monitoring logic stack to execute the set of operations.

3. The apparatus of claim 2, wherein the hardware and software monitoring logic stack includes at least one of the platform compute circuitry or the telemetry function accelerator circuitry.

4. The apparatus of claim 3, wherein the application assignment interface data structure further includes, for each application instance, an instance criticality level.

5. The apparatus of claim 4, wherein the SLA monitoring circuitry is to:
instantiate the first monitoring function in at least the telemetry function accelerator circuitry in response to the instance criticality level being high; and
instantiate the first monitoring function in at least the platform compute circuitry in response to the instance criticality level being less than high.

6. The apparatus of claim 5, wherein the SLA monitoring circuitry is to:
monitor a utilization rate of the platform compute circuitry; and
in response to the utilization rate being below a maximum threshold value, cause at least a portion of the platform compute circuitry to execute the first monitoring function.

7. The apparatus of claim 1, wherein the application assignment interface data structure further includes, for each application instance, a frequency time value to indicate a monitoring function frequency of execution and wherein the SLA monitoring circuitry further to:
manage a timer to count down the frequency time value; and
cause the first monitoring function to execute after the timer expires.

8. The apparatus of claim 1, wherein the monitoring function registry interface data structure includes, for each monitoring function, a telemetry metric list of telemetry metrics to be collected.

9. The apparatus of claim 8, wherein the SLA monitoring circuitry is further to provide a QoS enforcing circuitry at least one of the function identifier of the first monitoring function, a current set of values of the telemetry metrics, and a result of the execution of the monitoring function.

10. The apparatus of claim 8, wherein the monitoring function includes at least one of an algorithm represented by an accelerated function, one or more operations to collect the telemetry metrics, or one or more sub-functions invoked to collect a set of telemetry metrics.

11. The apparatus of claim 1, wherein the application assignment interface data structure further includes, for each application instance, a listing of one or more corrective actions to trigger in response to the SLA monitoring circuitry generating the QoS enforcement callback.

12. At least one non-transitory computer-readable storage medium comprising instructions that, when executed, cause one or more processors of a machine to at least:
cause storage of a monitoring function registry interface data structure to list a set of monitoring functions, the monitoring function registry interface data structure providing, for each monitoring function in the set, a unique universal function identifier and a function descriptor; and
cause storage of an application assignment interface data structure to list application instances, the application assignment interface data structure providing, for each application instance, an application identifier, an application service level agreement (SLA) definition, and the function descriptor to enable a link to a first monitoring function; and
instantiate the first monitoring function for a first application instance in a hardware and software monitoring logic stack, the hardware and software monitoring logic stack including at least one of a platform compute circuitry or a telemetry function accelerator circuitry;
cause the first monitoring function to execute in the hardware and software monitoring logic stack; and
generate a quality of service (QoS) enforcement callback in response to a violation of the SLA definition.

13. The at least one non-transitory computer-readable storage medium of claim 12, wherein the instructions, when executed, cause the one or more of the processors of the machine to:
parse the first monitoring function into a set of operations; and
configure the hardware and software monitoring logic stack to execute the set of operations.

14. The at least one non-transitory computer-readable storage medium of claim 13, wherein the application assignment interface data structure further includes, for each application instance, an instance criticality level.

15. The at least one non-transitory computer-readable storage medium of claim 14, wherein the instructions, when executed, cause the one or more of the processors of the machine to:
instantiate the first monitoring function in at least the telemetry function accelerator circuitry in response to the instance criticality level being high; and
instantiate the first monitoring function in at least the platform compute circuitry in response to the instance criticality level being less than high.

16. The at least one non-transitory computer-readable storage medium of claim 15, wherein the instructions, when executed, cause the one or more of the processors of the machine to:
monitor a utilization rate of the platform compute circuitry; and
in response to the utilization rate being below a maximum threshold value, cause at least a portion of the platform compute circuitry to execute the first monitoring function.

17. The at least one non-transitory computer-readable storage medium of claim 12, wherein the application assignment interface data structure further includes, for each application instance, a frequency time value to indicate a monitoring function frequency of execution, and wherein the instructions, when executed, cause the one or more of the processors of the machine to:
manage a timer to count down the frequency time value; and
cause the first monitoring function to execute after the timer expires.

18. The at least one non-transitory computer-readable storage medium of claim 12, wherein the monitoring function registry interface data structure includes, for each monitoring function, a telemetry metric list of telemetry metrics to be collected.

19. The at least one non-transitory computer-readable storage medium of claim 18, wherein the instructions, when executed, cause the one or more of the processors of the machine to:
provide a QoS enforcing circuitry at least one of the function identifier of the first monitoring function, a current set of values of the telemetry metrics, and a result of the execution of the monitoring function.

20. (canceled)

21. (canceled)

22. An apparatus, comprising:
processor circuitry including one or more of:
at least one of a central processor unit, a graphic processor unit or a digital signal processor, the at least one of the central processor unit, the graphic processor unit or the digital signal processor having control circuitry to control data movement within the processor circuitry, arithmetic and logic circuitry to perform one or more first operations corresponding to instructions, and one or more registers to store a result of the one or more first operations, the instructions in the apparatus;
a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations; or
an Application Specific Integrate Circuitry (ASIC) including logic gate circuitry to perform one or more third operations;
the processor circuitry to perform at least one of the one or more first operations, the one or more second operations or the one or more third operations to instantiate:
a monitoring function registry interface data structure to list a set of monitoring functions, the monitoring function registry interface data structure including, for each monitoring function in the set, a unique universal function identifier and a function descriptor;
application assignment interface data structure to list application instances, the application assignment interface data structure including, for each application instance, an application identifier, an application service level agreement (SLA) definition, and the function descriptor to enable a link to a first monitoring function;
SLA monitoring circuitry, the SLA monitoring circuitry to:
instantiate the first monitoring function for a first application instance in a hardware and software monitoring logic stack;
cause the first monitoring function to execute in the hardware and software monitoring logic stack; and
generate a quality of service (QoS) enforcement callback in response to a violation of the SLA definition.

23. The apparatus of claim 22, wherein the processor circuitry to perform at least one of the one or more first operations, the one or more second operations or the one or more third operations to instantiate:
telemetry function accelerator circuitry to:
parse the first monitoring function into a set of operations; and
configure the hardware and software monitoring logic stack to execute the set of operations.

24. The apparatus of claim 23, wherein the hardware and software monitoring logic stack includes at least one of accelerator circuitry, the processor circuitry, or the telemetry function accelerator circuitry.

25. The apparatus of claim 24, wherein the application assignment interface data structure further includes, for each application instance, an instance criticality level.

26. The apparatus of claim 25, wherein the SLA monitoring circuitry is to:
instantiate the first monitoring function in at least the telemetry function accelerator circuitry in response to the instance criticality level being high; and
instantiate the first monitoring function in at least a platform compute circuitry in response to the instance criticality level being less than high.

27. The apparatus of claim 26, wherein the SLA monitoring circuitry is to:
monitor a utilization rate of the platform compute circuitry; and
in response to the utilization rate being below a maximum threshold value, cause at least a portion of the platform compute circuitry to execute the first monitoring function.

28. (canceled)

29. (canceled)

30. (canceled)

31. (canceled)

32. (canceled)
